(19) United States
(12) Patent Application Publication
(10) Pub. No.: US 2014/0129272 A1
(43) Pub. Date: May 8, 2014

(54) SYSTEM AND METHOD FOR MANAGING SERVICE RESTORATION IN A UTILITY NETWORK

(71) Applicant: Pacific Gas and Electric Company, San Francisco, CA (US)

(72) Inventor: Ryan Christopher Hanley, Berkeley, CA (US)

(73) Assignee: Pacific Gas and Electric Company, San Francisco, CA (US)

(21) Appl. No.: 14/072,712

(22) Filed: Nov. 5, 2013

Related U.S. Application Data
(60) Provisional application No. 61/722,704, filed on Nov. 5, 2012.

(51) Int. Cl. G06Q 10/06; G06Q 50/06

(52) U.S. Cl. CPC G06Q 10/06311; G06Q 50/06
USPC 705/7.13

(57) ABSTRACT

Some embodiments include a computer-implemented restoration work plan system and method comprising a processor, a non-transitory computer-readable storage medium in data communication with the processor, and a service restoration management system executable by the processor, and configured to prepare a first distribution system operations storm outage prediction project model forecast substantially in real time based at least in part on a weather forecast. Some embodiments include calculating and displaying an expected outage category level substantially in real time for each division based on the weather forecast, and resource numbers comprising the number of personnel needed to respond to outages and the number of crew needed to repair outages. Some embodiments include calculating and displaying an estimated time of repair within the repair plan based at least in part on a historical productivity assumption, the productivity assumption including a historical rate of assessment and repair and percentage of outages requiring repair.

### RELATED APPLICATIONS

This application claims the priority 35 U.S.C. §119 to U.S. Provisional Patent Application No. 61/722,704 entitled “System and Method for Managing Service Restoration in a Utility Network” filed on Nov. 5, 2012, the entire contents of which are incorporated herein by reference in its entirety.

### BACKGROUND

Many utility customers have become accustomed to extremely reliable networks, and have come to depend upon such networks for both necessities and conveniences of everyday life. Accordingly, in addition to key performance indicators such as CAIDI, SAIDI and SAFI, customer satisfaction scores are often negatively affected when network service is interrupted for an extended period of time due to severe weather or other adverse conditions.

Systems have been developed to help restore service more quickly and cost-effectively. However, prior art systems typically do not provide a comprehensive infrastructure for supporting service restoration efforts which includes modeling of costs and benefits using a variety of resources to help optimize the restoration process. For example, prior art systems typically do not recommend an optimized restoration strategy taking into account how strong of a need a customer segment has for quick restoration time and the cost the utility must incur in providing faster restoration time. Additionally, historical outage data including a storms severity related to past outage and the effect of any outage at the customer level is generally not used effectively to augment input data to optimize assessment and repair at the division level.

### SUMMARY

Some embodiments include a computer-implemented restoration work plan system comprising a processor, a non-transitory computer-readable storage medium in data communication with the processor. Some embodiments include a the non-transitory computer-readable storage medium including a service restoration management system executable by the processor, to prepare a first distribution system operations storm outage prediction project model forecast including at least an assessment plan and a repair plan. In some embodiments, the executable steps can include calculating and displaying an expected outage category level substantially in real time for each division based at least in part on at least one variable of the weather forecast; calculating and displaying a sustained outage for each division based at least in part on the expected outage category level and a historical sustained outage based on the expected outage category; calculating and displaying a customers experiencing sustained outages figure report based at least in part on a historical relationship of the calculated sustained outage to a historical customers experiencing sustained outages figure of each division; and calculating and displaying estimated resource numbers based on the calculated sustained outage, the resource numbers comprising the number of personnel needed to respond to outages and the number of crew needed to repair outages.

In some embodiments, the system can further comprise the service restoration management system being executable by the processor and configured to calculate and display an estimated time of assessment of an expected outage within the assessment plan, and calculate and display an estimated time of repair within the repair plan based at least in part on a historical productivity assumption. In some embodiments, the productivity assumption includes a historical rate of assessment and repair and percentage of outages requiring repair.

Some embodiments of the system include resource numbers that are based on the calculated sustained outage and the number of crews and personnel needed to repair outages within 12 hours when the outage category level is 3 or lower. Some other embodiments of the system include resource numbers that are based on the calculated sustained outage and the number of crews and personnel needed to repair outages within 24 hours when the outage category level is 4 or greater.

In some embodiments of the invention, the system includes an outage category level that can range in increments of 1 between 1 and 5, and wherein the outage category level can be assigned a qualitative weather consisting of at least one of a “adverse weather unlikely”, “adverse weather possible”, “adverse weather likely”, “extreme weather possible” and “extreme weather likely”.

In some embodiments, the first distribution system operations storm outage prediction project model forecast is prepared for each division for a successive four days. In other embodiments, the first distribution system operations storm outage prediction project model forecast is calculated and displayed as one day increments. In some further embodiments, the one day increments includes a forecasted timing of most intense outage producing forecast weather.

Some embodiments of the invention comprise a system that includes a service restoration management system that comprises a non-transitory computer-readable storage medium comprising instructions to perform a restoration option scenario analysis, in which the instructions are executable by the processor. The restoration option scenario analysis is configured to calculate at least a second distribution system operations storm outage prediction project model forecast using the service restoration management system in addition to the first distribution system operations storm outage prediction project model forecast in which at least one of the expected outage category level, the customers experiencing sustained outages figure, resource numbers, the estimated time of assessment and the estimated time of repair is different from that used in the first distribution system operations storm outage prediction project model forecast. Some embodiments calculate and display at least the first distribution system operations storm outage prediction project model forecast including a first repair plan and the at least second distribution system operations storm outage prediction project model forecast including a second repair plan within a resource decision tool.

In some embodiments of the system, the first repair plan includes a first plan cost and the second repair plan includes a second plan cost, and the restoration option scenario analysis further includes a graphical display comparing the first plan cost with at least the second plan cost. In some further embodiments, the repair plan further comprises a plan cost based at least on the estimated time of repair.

Some embodiments of the invention include a total system cost and a lowest system cost that can be determined based on the estimated time of repair and the plan cost and a societal cost based on the sustained outage and estimated time of repair.

In some embodiments, resource numbers are calculated based on transferred resources, the transferred resources including personnel or crew or both initially located outside of the division. In some embodiments, the repair plan further comprises a plan cost based at least on the estimated time of repair and a transferred resources cost.

Some embodiments of the invention include a service restoration management system that comprises a non-transitory computer-readable storage medium comprising instructions to perform a divisional estimated time of repair forecast comparison, the instructions executable by the processor, and configured to calculate estimated time of repair across a plurality of divisions, and identify divisions with resource needs based on sustained outage for each division and resource numbers available locally within the division, and calculate and display resource numbers based on transferred resources, the transferred resources including personnel or crew or both initially located outside of the division. In some further embodiments, calculating and displaying an estimated time of assessment of an expected outage within the assessment plan and calculating and displaying an estimated time of repair within the repair plan occurs within 0.5 seconds or less of calculating and displaying an expected outage category level.

Some embodiments of the invention include a non-transitory computer-readable storage medium storing computer-readable instructions, which when executed by at least one processor of a computer, cause a restoration work plan system to perform steps comprising receiving and storing on a computer-readable storage medium a first file comprising at least one weather forecast including at least one storm comprising a storm type and size for at least one division. Using the least one processor, some embodiments include preparing a first distribution system operations storm outage prediction project model forecast including at least an assessment plan and a repair plan by performing the steps comprising calculating and displaying an expected outage category level substantially in real time for each division based at least in part on at least one variable of the weather forecast. Some embodiments include calculating and displaying a sustained outage for each division based at least in part on the expected outage category level and a historical sustained outage based on the expected outage category, and calculating and displaying a customers experiencing sustained outages figure report based at least in part on a historical relationship of the calculated sustained outage to a historical customers experiencing sustained outages figure of each division. Further, some embodiments include calculating and displaying estimated resource numbers based on the calculated sustained outage, the resource numbers comprising the number of personnel needed to respond to outages and the number of crew needed to repair outages.

Some embodiments include calculating and displaying an estimated time of assessment of an expected outage within the assessment plan, and calculating and displaying an estimated time of repair within the repair plan based at least in part on a historical productivity assumption. The productivity assumption can include a historical rate of assessment and repair and percentage of outages requiring repair.

Some embodiments include a method in which a distribution system operations storm outage prediction project model forecast is prepared for each division for a successive four days. In some other embodiments, the distribution system operations storm outage prediction project model forecast is calculated and displayed as one day increments, and in some further embodiments, they include forecasted timing of most intense outage producing forecast weather.

Some embodiments of the invention include a restoration analysis. For example, some embodiments include a method of scenario analysis comprising the steps of preparing at least a second distribution system operations storm outage prediction project model forecast using the method of preparing the first distribution system operations storm outage prediction project model forecast in which at least one of the expected outage category level, the customers experiencing sustained outages figure, resource numbers, the estimated time of assessment and the estimated time of repair is different from that used in the first distribution system operations storm outage prediction project model forecast. The method also includes displaying at least the first distribution system operations storm outage prediction project model forecast including a first repair plan and the at least second distribution system operations storm outage prediction project model forecast including a second repair plan within a resource decision tool.

In some embodiments, the first repair plan includes a first plan cost and the second repair plan includes a second plan cost, and the restoration option scenario analysis further includes a graphical display comparing the first plan cost with at least the second plan cost. In some embodiments, the repair plan further comprises a plan cost based at least on the estimated time of repair.

In some embodiments, a total system cost and a lowest system cost can be determined based on the estimated time of repair and the plan cost and a societal cost based on the sustained outage and estimated time of repair. In some embodiments, the resource numbers are calculated based on transferred resources, the transferred resources including personnel or crew or both initially located outside of the division. Further, in some embodiments, the repair plan further comprises a plan cost based at least on the estimated time of repair and a transferred resources cost.

Some embodiments include a computer-implemented method of developing a divisional estimated time of restoration forecast comparison by calculating estimated time of repair across a plurality of divisions, identifying divisions with resource needs based on sustained outage for each division and resource numbers available locally within the division, and calculating resource numbers based on transferred resources, the transferred resources including personnel or crew or both initially located outside of the division.

### DESCRIPTION OF THE DRAWINGS

FIG. 1 is a restoration work plan schema according to one embodiment of the invention.

FIG. 2A is an overview of a planning process using one embodiment of the invention.

FIG. 2B shows one example of a system architecture implementation useful for performing one or more of the methods of the service restoration management system according to one embodiment of the invention.

FIG. 3 is an overview of a system and method for forecasting expected outages and resources required prior to an event based on weather. This forecast serves as an input to the restoration strategy development, according to one embodiment of the invention.

FIG. 4 is an overview of a system and method for managing service restoration providing data input for resource counts according to one embodiment of the invention.

FIGS. 5A-5B provide an overview of a system and method for managing service restoration helping assess current restoration forecasts by geographic area using a restoration work plan according to one embodiment of the invention.

FIG. 6 provides one embodiment of a resource decision tool display of a system and method for managing service restoration according to one embodiment of the invention.

FIG. 7 is an overview of a system and method for managing service restoration helping to determine an ideal ETOR target to minimize total economic event cost according to one embodiment of the invention.

FIG. 8 is an overview of a system and method for managing service restoration helping identify resource gaps and develop a resource transfer strategy according to one embodiment of the invention.

FIG. 9 is an overview of a system and method for managing service restoration helping compare ETOR forecasts by geographic area according to one embodiment of the invention.

FIG. 10A is an overview of a system and method for managing service restoration providing cost estimates and resource summaries, performance and current status dashboards according to one embodiment of the invention.

FIG. 10B illustrates a resource tracking dashboard generated by the system and method for managing service restoration according to one embodiment of the invention.

FIG. 10C illustrates a event summary dashboard generated by the system and method for managing service restoration according to one embodiment of the invention.

FIG. 10D illustrates a current status dashboard generated by the system and method for managing service restoration according to one embodiment of the invention.

FIGS. 11A-C is an example of the productivity assumptions used to calculate ETOR forecasts in the restoration work plan, according to one embodiment of the invention.

FIGS. 12A-G is as example of the current outage and customer counts that can be used as feeds for the calculation of ETOR estimates in the restoration work plan, according to one embodiment of the invention.

FIGS. 13A-D is an example of the graphical comparison of ETOR forecasts by geographic area, according to one embodiment of the invention.

FIGS. 14A-B is an example of the data comparison of ETOR forecasts by geographic area, according to one embodiment of the invention

FIGS. 15A-C is an example of the read out of the scenario analysis tool to compare various restoration scenarios, according to one embodiment of the invention.

FIGS. 16A-H is an example of the resource tool to develop the most efficient use of resources across geographic areas, based on the current resource count and chosen restoration strategy, according to one embodiment of the invention.

FIGS. 17A-C is an example of the financial estimate of event cost based on regression analysis of historical events, according to one embodiment of the invention.

FIGS. 18A-C is an example of the financial estimate of event cost based on planned resources dedicated to an event, according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

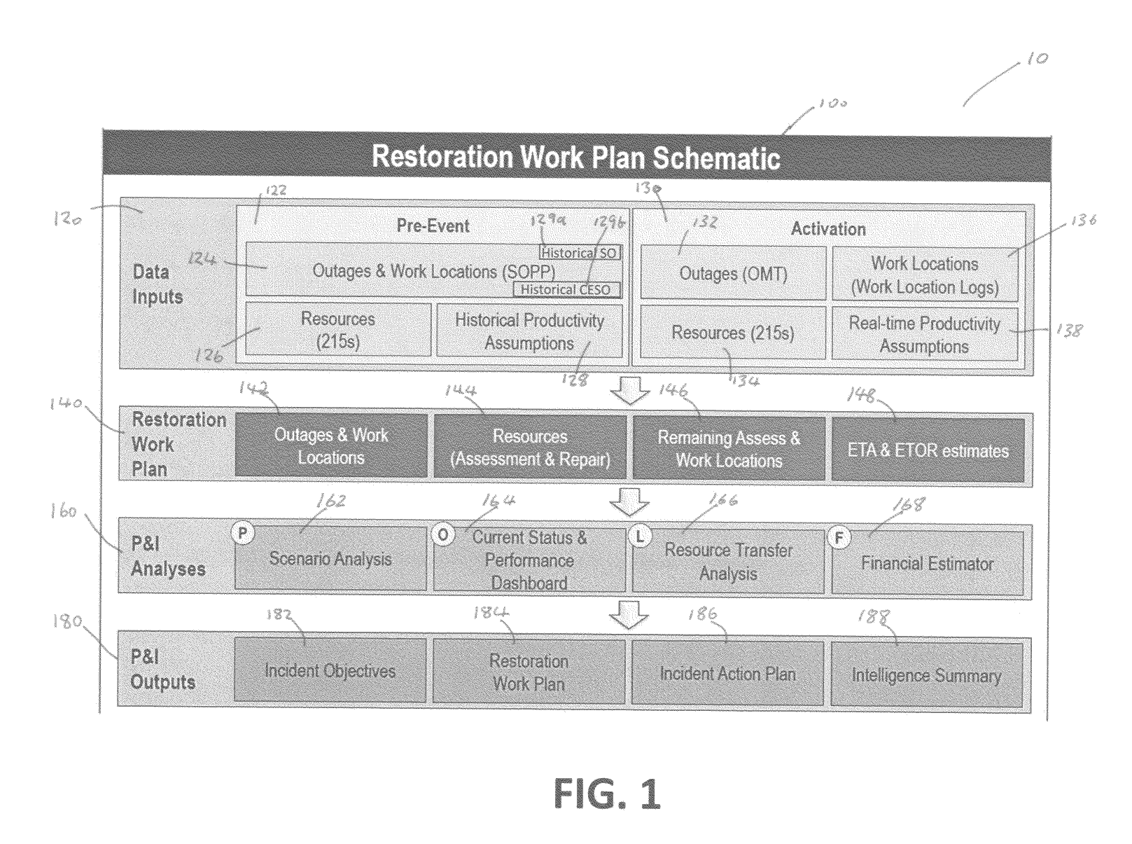

FIG. 1 shows a restoration work plan system 100 according to one embodiment of the invention. The restoration work plan system 100 as shown provides a functional view of an overall service restoration management system 10, and includes a plurality of data inputs 120 that can be processed by the service restoration management system 10 to output a plurality of outputs 180 within the restoration work plan 140. Some embodiments of the restoration work plan system 100 include data inputs 120 that include pre-event 122 data and activation data 130. For example, the pre-event data 122 can include outages and work locations (SOPP) 124, resources 126, as well as historical productivity assumptions 128. The plurality of data inputs 120 can also include a historical SO data 129a and a historical CESO data 129b, and the historical relationship between the historical SO data 129a and a historical CESO data 129b. The activation data 130 can include data related to initiated and ongoing restoration work including outages 132, resources 134, work locations 136, and real-time productivity assumptions 138. Further, the restoration work plan system 100 can provide a user with a plurality of profit and loss (“P&l”) analysis 160 and a plurality of profit and loss outputs 180.

In some embodiments, a user may have access to various information generated as part of the restoration work plan 140 including outages and work locations 142. In some further embodiments, a user may have access to remaining assessment and work locations 146, and estimated time of assessments (hereinafter “ETA”) and estimated time of restoration (hereinafter “ETOR”) estimates 148.

In some further embodiments, the service restoration management system 10 can enable a user to perform a variety of financial simulations as part of a restoration work plan system 100. For example, the service restoration management system 10 can enable user to perform a profit and loss analysis 160 using one or more financial analysis models including a scenario analysis 162, a resource transfer analysis 166, and a financial estimator 168. In some embodiments, a user can access data related to the current status of a restoration work plan 140 of the restoration work plan system 10 through a current status and performance dashboard 164. In some other embodiments, a user can use the service restoration management system 10 to generate profit and loss outputs 180 including incident objectives 182, a restoration work plan 184, an incident action plan 186, along with an intelligence summary 188.

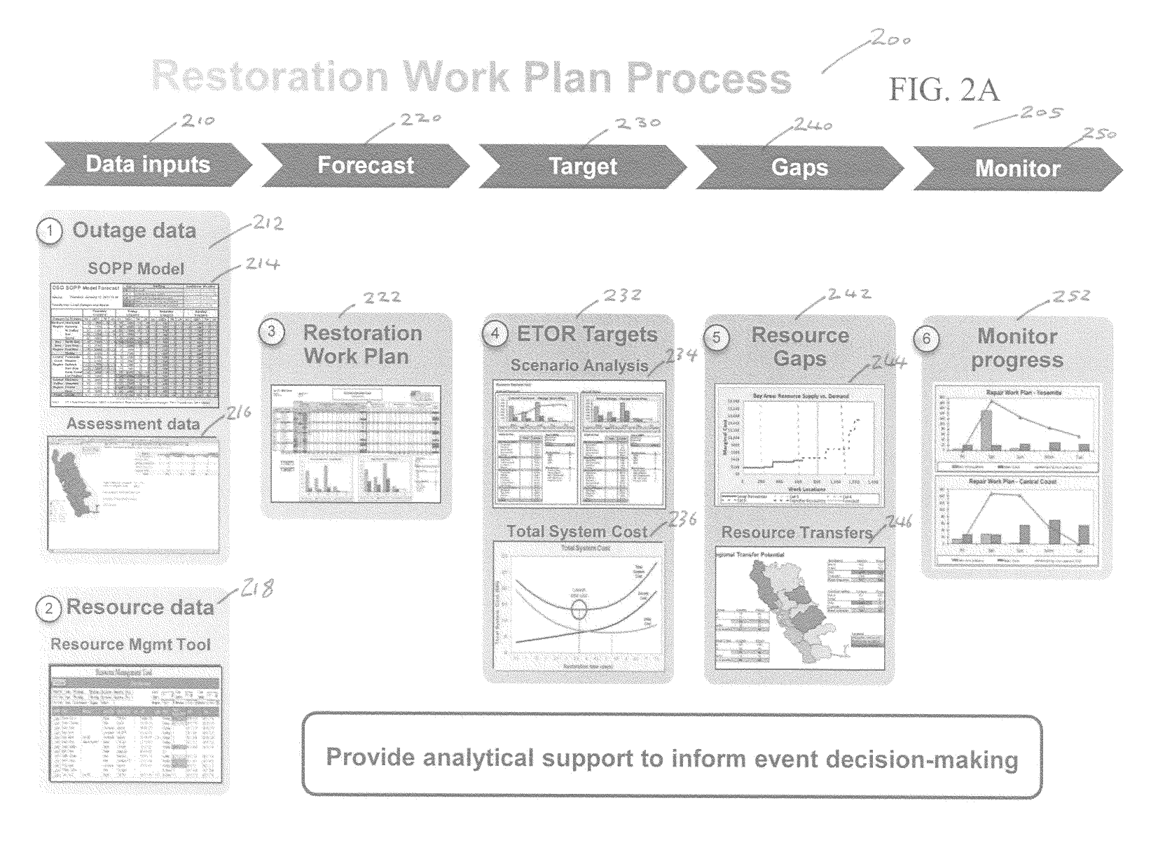

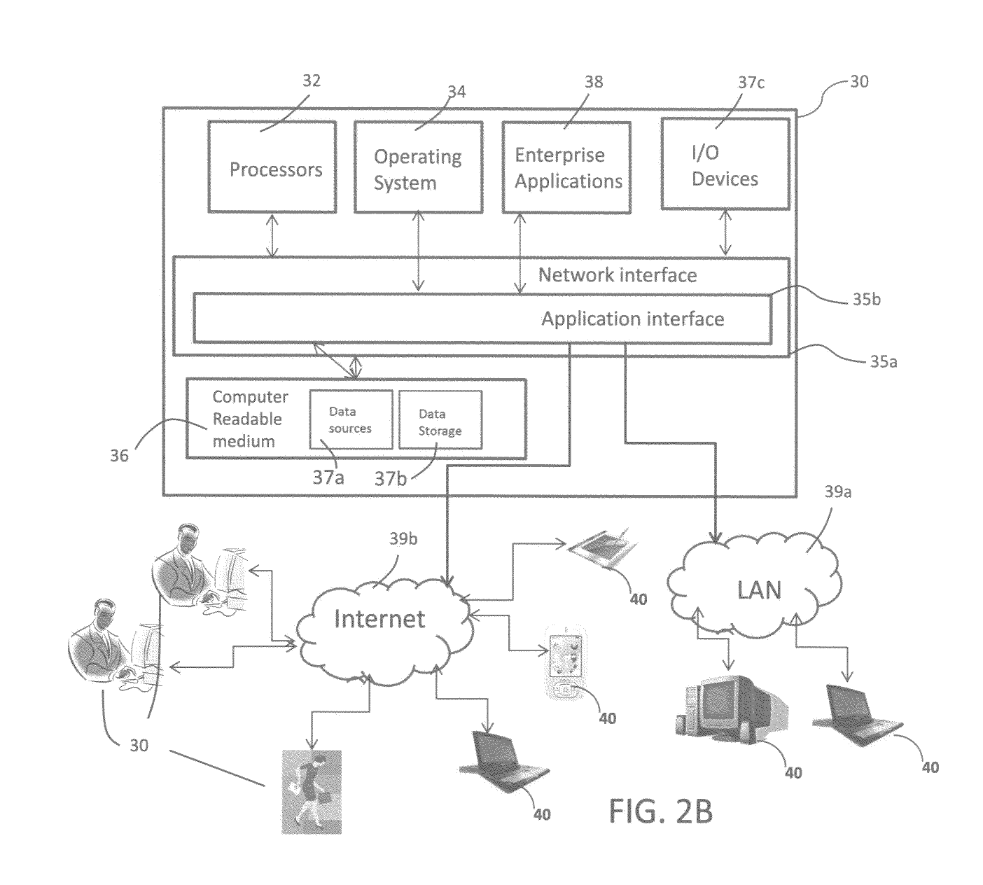

In some embodiments, the restoration work plan system 100 can be run as service restoration management system 10 by processing at least one embodiment of the planning process 200 shown in FIG. 2A as a computer-implemented method (e.g., using a system architecture 30 shown in FIG. 2B). For example, FIG. 2A is an overview of a planning process 200 that forms part of the service restoration management system 10 that can be used when performing at least one method of the service restoration management system 10. As shown, some embodiments of the invention include a plurality of planning modules 205 that function as steps and/or stages during the planning process 200 within the service restoration management system 10. For example, the planning process 200 can include a data input module 210, a forecast module 220 used to provide simulated assessment and resource forecasts, a target module 230 used to enable a user to determine a target ETOR based on length of outage and incremental cost, a gaps module 240 used to determine resource allocation between one or more divisions, and a monitor module 250 used to monitor the performance of assessment and repair across one or more divisions. In some embodiments, each of the steps of the planning process 200 embodied by the modules 210, 220, 230, 240, and 250 can occur substantially sequentially. In other embodiments, any one or number of the steps of the planning process 200 embodied by the modules 210, 220, 230, 240, and 250 can occur substantially in parallel.

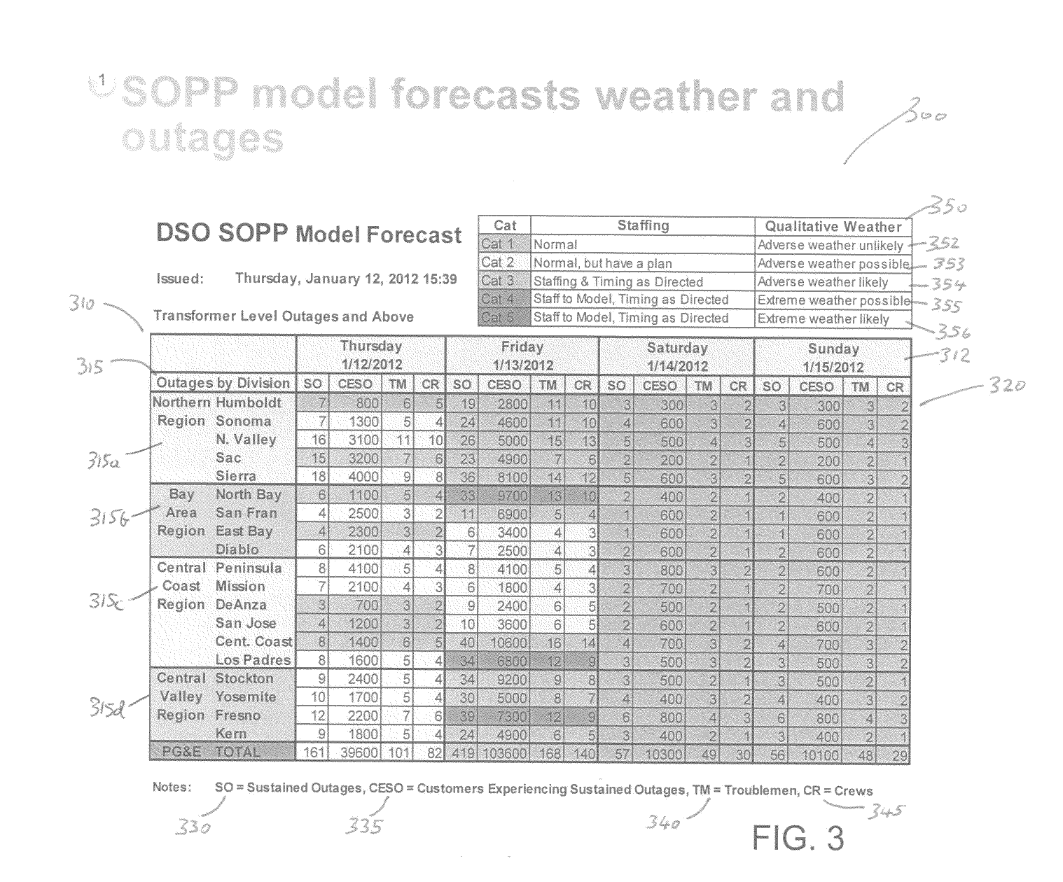

Some embodiments of the service restoration management system 10 can include a distribution system operations storm outage prediction project model (hereinafter “DSO SOPP”). The DSO SOPP can include one or more models that can be used to predict the number of electrical sustained outages figure (herein after “SO”) at the transformer level and above. In some embodiments, the DSO SOPP (e.g., DSO SOPP 300 shown in FIG. 3) includes several models based on various weather-induced environmental changes. For example, in some embodiments, the DSO SOPP 300 includes “WindSOPP”, taking into account storm-induced winds, “SnowSOPP”, taking into account storm-induced snow, and “HotSOPP”, taking into account temperature and temperature variations induced by a inclement weather, including storms. In some embodiments, the DSO SOPP 300 model can utilize weather forecast data. In other embodiments, the DSO SOPP 300 model can utilize weather observations (such as live and delayed weather observations). In some other embodiments, the DSO SOPP 300 model can utilize historical outage data and may be used to supplement or in place of weather forecast and observation data (useful for example on fair weather days). On fair weather days for example, a historical outage background estimator (“HOBiE”) can be used.

In some embodiments, an SO severity level (see 330 in FIG. 3), and a customers experiencing sustained outages figure (hereinafter referred to as “CESO”, and shown as 335 in FIG. 3) can be calculated based on historical data. For example, in some embodiments, a SO severity level 330 and a CESO 335 can be estimated from a 24 day moving average of fair weather days during the same period over a 5 year historical period. In some embodiments, a relationship between a historical SO 129a and a historical CESO 129b can be used. For example, in some embodiments, a CESO 335 may be calculated based at least in part on a historical relationship of the SO severity level 330 to a historical CESO 335 of each division.

At least in the embodiments as described, the DSO SOPP 300 model can be used to calculate an SO severity level 330. For example, in some embodiments, adverse weather categories 1 to 5 can be used to indicate an SO severity level 330. Further, in some embodiments, resource needs can be calculated based on the SO severity level 330. For example, in some embodiments, the resource needs such as individual personnel (shown as “troublemen” 340 in FIG. 3) and one or more crew 345 can be established to some confidence level based at least in part on the SO severity level 330.

Referring to FIG. 3, and the category table 350, in some embodiments, a level 1 severity level can be assigned a “Cat 1”, with a staffing level of “normal” for a qualitative weather defined as “fair” 352. A level 2 severity level can be assigned a “Cat 2”, with a staffing level of “normal but have a plan” available for a qualitative weather defined as “adverse weather possible” 353. A level 3 severity level can be assigned a “Cat 3”, with a staffing level of “staffing and timing as directed” for qualitative weather defined as “adverse weather likely” 354. Further, a level 4 severity level can be assigned a “Cat 4”, with a staffing level of “staff to model, timing as directed” for qualitative weather defined as “extreme weather possible” 355, and finally, a level 5 severity level can be assigned a “Cat 5”, with a staffing level of “staff to model, timing as directed” for qualitative weather defined as “extreme weather likely” 356. Further, in some embodiments, a color code can be assigned to one or more SO severity levels 330. For example, in some embodiments, a “Cat 1” 352 severity level can be assigned a blue color, the “Cat 2” 353 may be assigned a tan color, the “Cat 3” 354 may be assigned a yellow color, the “Cat 4” 355 may be assigned an orange color, and the “Cat 5” 356 may be assigned a red color. In other embodiments, other colors or combinations of colors may be used to allow a user to identify and associated any data used or calculated by the service restoration management system 10.

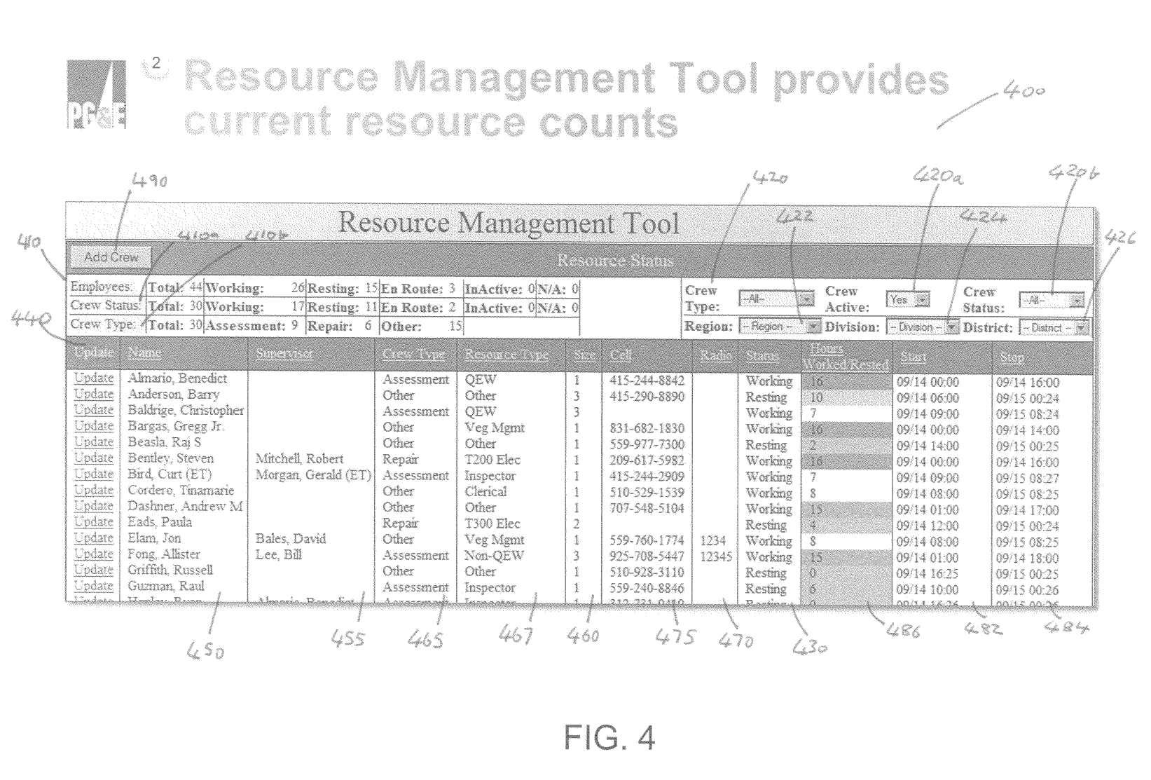

In some embodiments, the planning process 200 as shown in FIG. 2A can use the DSO SOPP model when performing at least one method of the service restoration management system 10. For example, as shown in FIG. 2A, the planning process 200 can include a data input module 210 that includes outage data 212 that may include displaying data 214 produced by the DSO SOPP 300 model. Assessment data 216 can also be displayed as part of the planning process 200, and resource data 218 can be displayed within a resource management tool (e.g., resource management tool 400 shown in FIG. 4).

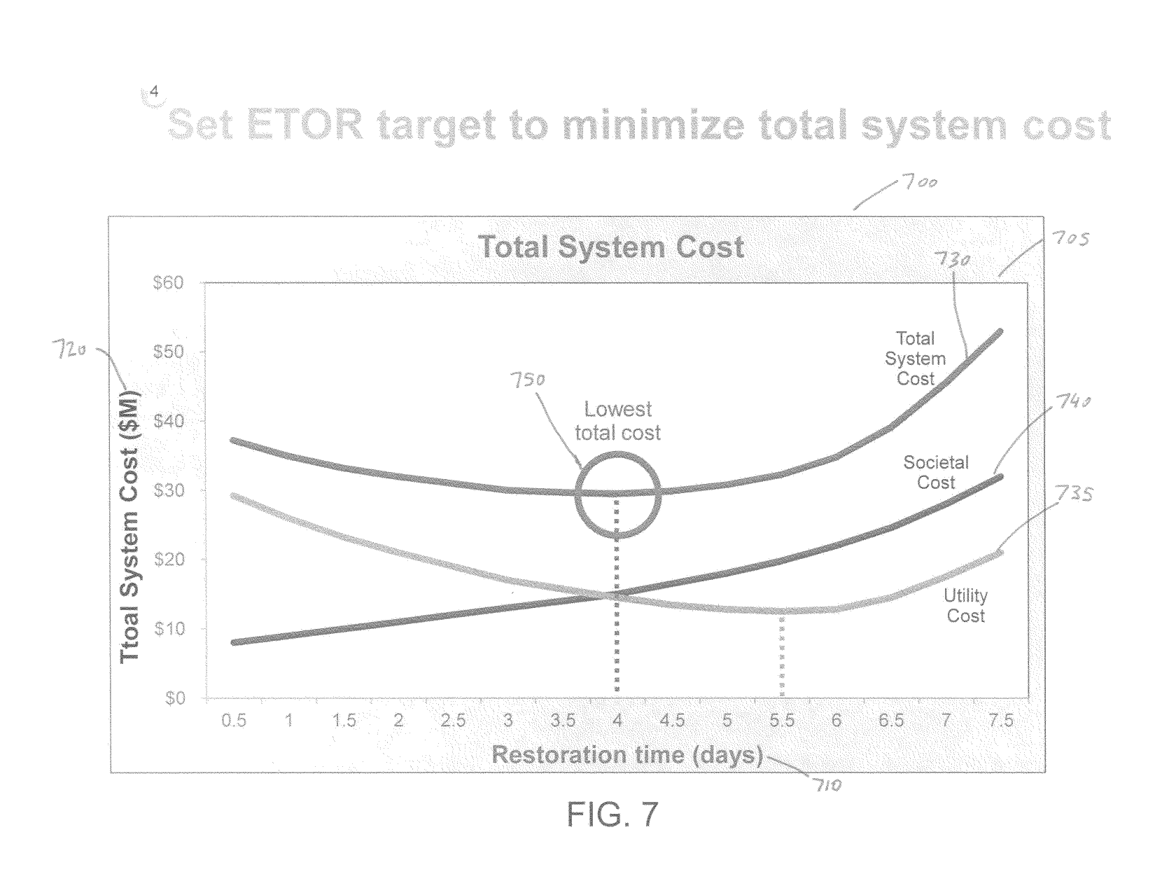

In some embodiments, outage data 212 and resource data 218 can be useful inputs for preparing a restoration work plan 222, with forecasts of when assessments and repairs will be completed (shown in FIG. 2A as ETOR targets 232). The outage data 212 and resource data 218 can also be useful inputs for preparing a scenario analysis 234, and provides tools for determining and optimizing the cost of the restoration work plan 222 (depicted as the total system cost chart 236, and discussed later as FIG. 7). In some embodiments, the costs include direct and indirect costs to the utility and all of its customers. In some embodiments, the work plan is not fixed, but evolves over time as resource gaps are identified and resolved.

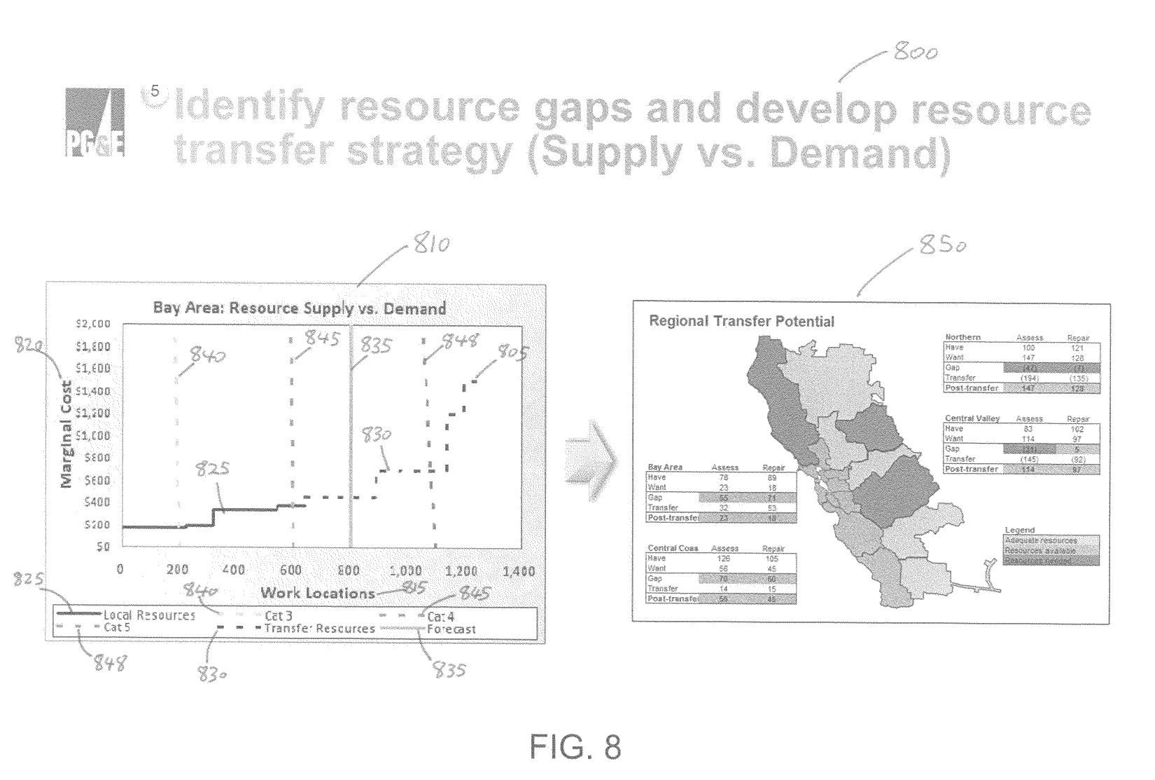

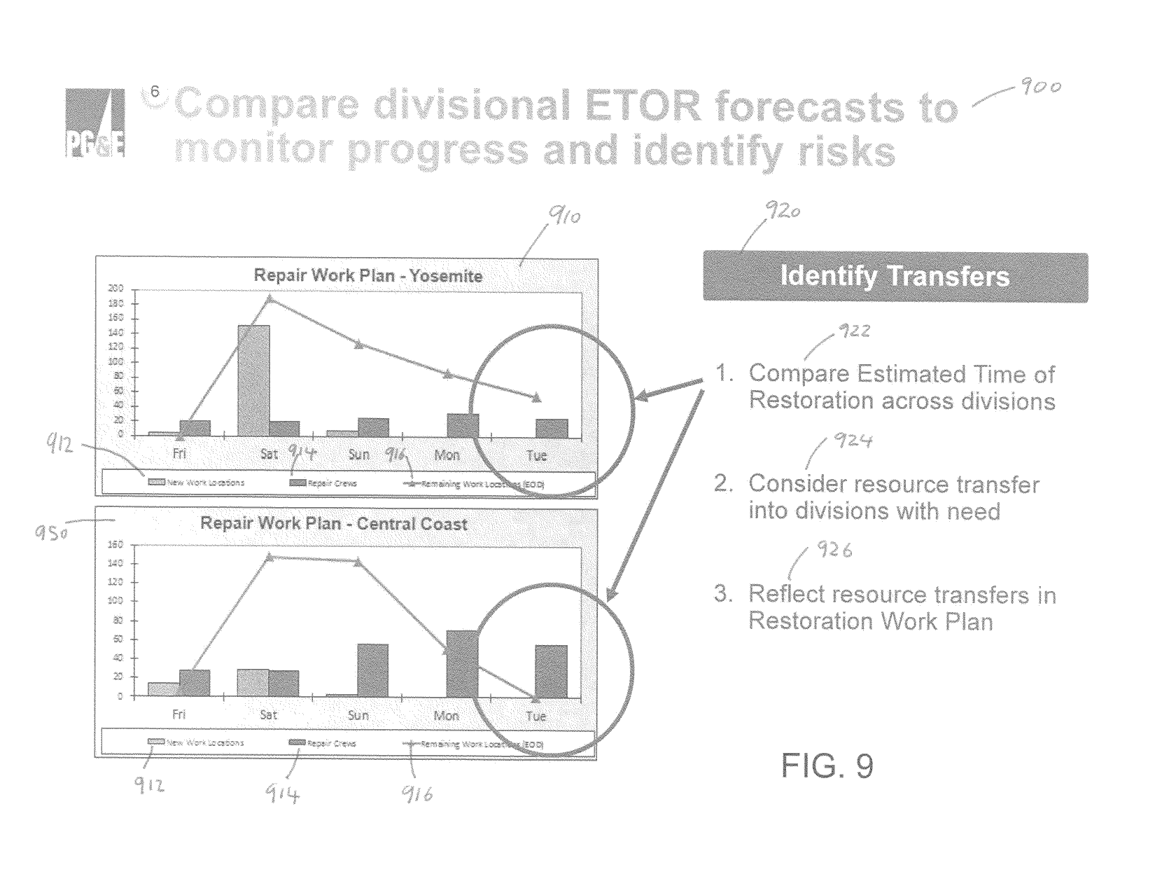

Some embodiments of the service restoration management system 10 provide multiple ways to monitor the progress of the work plan and to refine the work plan as needed. In some embodiments, the planning process 200 can include the ability to calculate resource gaps 242, including supply versus demand gaps 244 and resource transfer 246, both of which are shown in more detail in FIG. 8. Moreover, some embodiments of the planning process 200 can include a progress monitor 252 (shown in more detail in FIG. 9).

FIG. 2B shows one example of a system architecture 30 implementation useful for performing one or more of the methods of the service restoration management system 10 according to at least one embodiment of the invention. As shown, the system 30 can include at least one computing device, including at least one or more processors 32. Some processors 32 may include processors 32 residing in one or more conventional server platforms. The system architecture 30 may include a network interface 35a and an application interface 35b coupled to at least one processors 32 capable of running at least one operating system 34. Further, the system architecture 30 may include a network interface 35a and an application interface 35b coupled to at least one processors 32 capable of running one or more of the software modules (e.g., enterprise applications 38). The software modules 38 can include server-based software platform that may include numerous other software modules suitable for hosting at least one account and at least one client account, as well as transferring data between one or more accounts.

Some embodiments of the invention also relate to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data are obtained over a network the data may be processed by other computers on the network, e.g. a cloud of computing resources.

With the above embodiments in mind, it should be understood that the invention can employ various computer-implemented operations involving data stored in computer systems. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

The system architecture 30 can include at least one computer readable medium 36 coupled to at least one data storage device 37b, at least one data source 37a, and at least one input/output device 37c. In some embodiments, the invention can also be embodied as computer readable code on a computer readable medium 36. The computer readable medium 36 may be any data storage device that can store data, which can thereafter be read by a computer system. Examples of the computer readable medium 36 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium 36 can also be distributed over a conventional computer network via the network interface 35a so that the computer readable code may be stored and executed in a distributed fashion. For example, in some embodiments, one or more components of the system architecture 30 can be tethered to send and/or receive data through a local area network (“LAN”) 39a. In some further embodiments, one or more components of the system architecture 30 can be tethered to send or receive data through an internet 39b (e.g., a wireless internet). In some embodiments, at least one software application 38 running on at least one processors 32 may be configured to be coupled for communication over a network 39a, 39b. In some embodiments, one or more components of the network 39a, 39b can include one or more resources for data storage, including any other form of computer readable media beyond the media 36 for storing information and including any form of computer readable media for communicating information from one electronic device to another electronic device. Also, in some embodiments, the network 39a, 39b may include wide area networks (“WAN”), direct connections (e.g., through a universal serial bus port) or other forms of computer-readable media 36, or any combination thereof. Also, various other forms of computer-readable media 36 may transmit or carry instructions to a computer 40, including a router, private or public network, or other transmission device or channel, both wired and wireless. The software modules 38 can be configured to send and receive data from a database (e.g., from a computer readable medium 36 including data sources 37a and data storage 37b that may comprise a database), and data can be received by the software modules 38 from at least one other source. In some embodiments, at least one of the software modules 38 can be configured within the system to output data to a user via at least one digital display (e.g., to a computer 40 comprising a digital display).

In some embodiments, one or more components of the network 39a, 39b can include a number of client devices which may be personal computers 40 including for example desktop computers, laptop computers, digital assistants, personal digital assistants, cellular phones, mobile phones, smart phones, pagers, digital tablets, internet appliances, and other processor-based devices. In general, a client device can be any type of external or internal devices such as a mouse, a CD-ROM, DVD, a keyboard, a display, or other input or output devices 37c.

In some embodiments, the system architecture 30 as described can enable one or more users 40 to receive, analyze, input, modify, create and send data to and from the system architecture 30, including to and from one or more enterprise applications 38 running on the system architecture 30. Some embodiments include at least one user 40 accessing one or more modules 10, including at least one enterprise applications 38 via a stationary I/O device 37c through a LAN 39a. In some other embodiments, the system architecture 30 can enable at least one user 40 accessing enterprise applications 38 via a stationary or mobile I/O device 37c through an internet 39a.

Some embodiments include a model forecast data table 310 that is displayed in a daily format 312. As shown in FIG. 3, in some embodiments, the model forecast data table 310 can display SO 330 data, CESO 335 data, TM 340 data or CR 345 data in a daily format 312 (in this example shown for a four consecutive day period). In some other embodiments, the daily format 312 can include more or less days, including a display for a single day. In some embodiments, the model forecast data table 310 illustrated in FIG. 3 can be displayed for SO severity level 330 (at the transformer level and above), and CESO 335 forecast for the day can displayed in real time per day of the week based on outages by district. For example, as shown in FIG. 3 illustrating the model forecast data table 310, the SO severity level 330 and CESO 335 can be displayed based on the outages by division 315.

In some embodiments, the division 315 can comprise a one or more geographic regions. For example, the division 315 could comprise one geographic region of state for example, in the example shown in FIG. 3, the division 315 could include a northern region 315a, a bay area region 315b, a central coast region 315c, and a central valley region 315d of the state of California. In some embodiments the division 315 may encompass an area larger or smaller than the regions 315a, 315b, 315c, and 315d shown in the model forecast display 300. For example, in some embodiments, the division 315 may include a city-block sized area. In some other embodiments, the division 315 may comprise an area equal to a town or city limits. In some further embodiments, the division 315 may comprise an area bounded by a county line. In some other embodiments, the division 315 may comprise an area covered within a state boundary.

In some embodiments, the data columns 320 can also show the personnel or troublemen 340 that may be needed to response to the outages 330 and the crews 345 estimated to be needed to repair the outages 330. As shown and depicted in FIG. 3, in some embodiments, any data in one of the data columns 320 can be assigned a severity category shown in the category table 350. For example, in some embodiments, any one of the category 352, 353, 354, 355, 356 can be assigned to one or more of data in the category columns 320. In some embodiments, any one of the data shown in data columns 320 can be assigned a color based on any one of the category 352, 353, 354, 355, 356. In some embodiments, the resource numbers for individual personnel (shown as troublemen 340) and crews 345 based on the SO 330 and CESO 335 are based on a forward 12 hour period for a category 3 (354) and for a 24 hour period for a category 4 (355). In some other embodiments (not shown), the data columns 320 can include timing within any specific day. For example, some embodiments can provide a time period within a 24 hour period for any day of the week and assigned any one of a category 352, 353, 354, 355, 356 for any outage by division 315. In some embodiments, the service restoration management system 10 includes a weather and outage forecasting module that analyzes forecast weather conditions and predicts outage and customer numbers and severity as well as staffing needs by a desired geographic region and time periods. Some embodiments of the invention may include data columns 320 that can communicate weather information (e.g., snow amounts) within a specific day. For example, some embodiments can provide new snowfall and time of snowfall within a 24 hour period for any day of the week.

FIG. 4 is an overview of a system and method for managing service restoration 10 providing data input for resource counts according to one embodiment of the invention. In some embodiments, the service restoration management system 10 receives inputs regarding crew identification, overall resources available with that crew 345, contact information, and the amount of work performed by the crew 345. These inputs can be used by the service restoration management system 10 or its users to determine which crews 345 are available and are best suited to be assigned to an SO 330 in any specific division 315. Some embodiments of the system and method for managing service restoration 10 include a resource status 400 (depicted in FIG. 4). In some embodiments, the system and method for managing service restoration 10 can include a display of resources 400 that is selectable by region and/or division 492 and/or district 494.

In some embodiments, the system and method for managing service restoration 10 can include a display of resources (the resource status 400) that includes employees 410 showing the employee status (e.g., a total number of employees, the number of working employees and resting employees). The resource status 400 may include an employee status 410 (showing for example crew status 410a and crew type 410b). The user can also be presented with the option to change crew 345 related information using the crew type selector 420, the crew active toggle 420a, and the crew status toggle 420b. Similarly, the user can assess resources in one or more regions, divisions and/or districts using the region selector 422, the division selector 424, and the district selector 426.

In some embodiments, the resource status 400 can provide resource personnel data 440. As shown in FIG. 4, in some embodiments, more detailed information can be provided on any member of a crew 345 including, but not limited to a crew person's name 450, their supervisor 455, their size 460, their classification (crew type 465). Further, information concerning communication equipment such as their radio 470 or cellular telephone 475 numbers can be viewed, along with the work date 480, a start time 482, stop time 484, and hours worked or assigned 486. Some embodiments include one or more user interface icons to allow data updating of the resource status 400. For example, a selectable button add crew 490 can be used to update one or more personnel data 440, and add new crew 490 can be used to update a resource status 400 with a new crew 345.

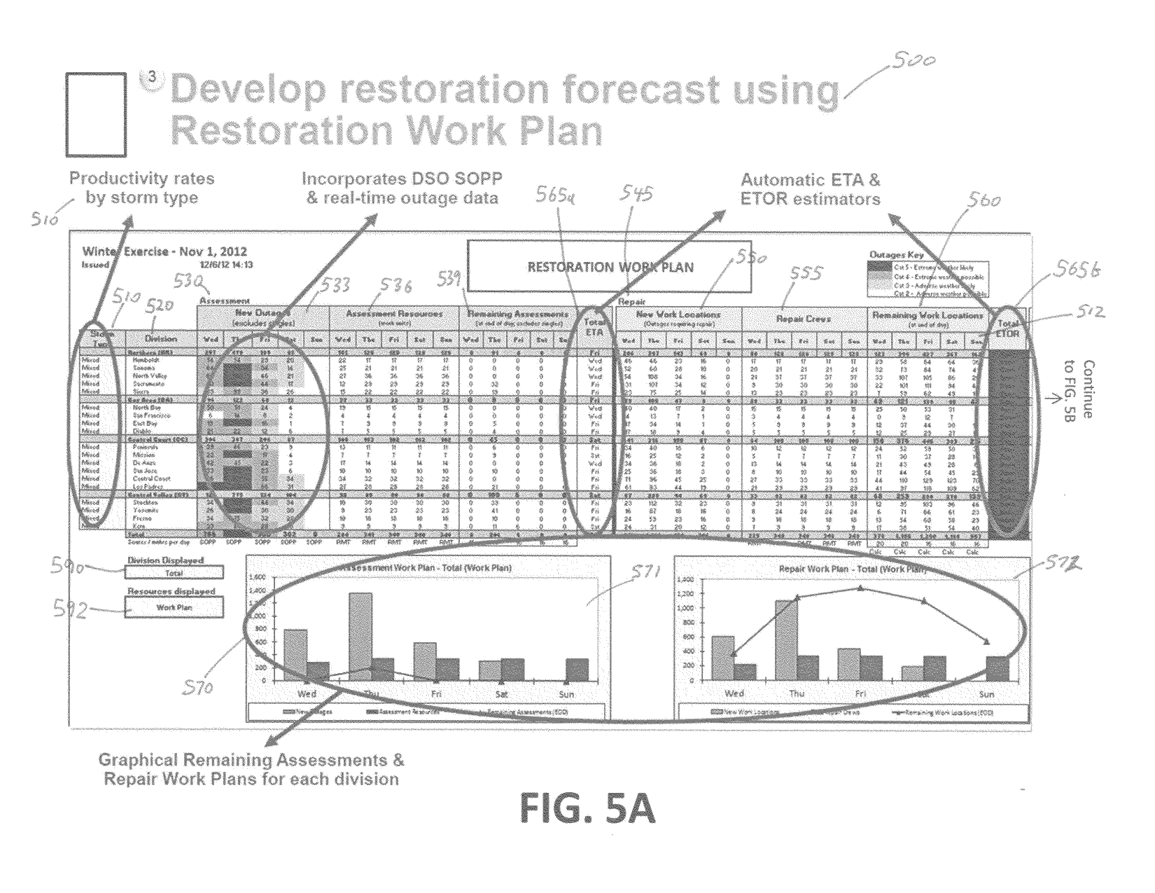

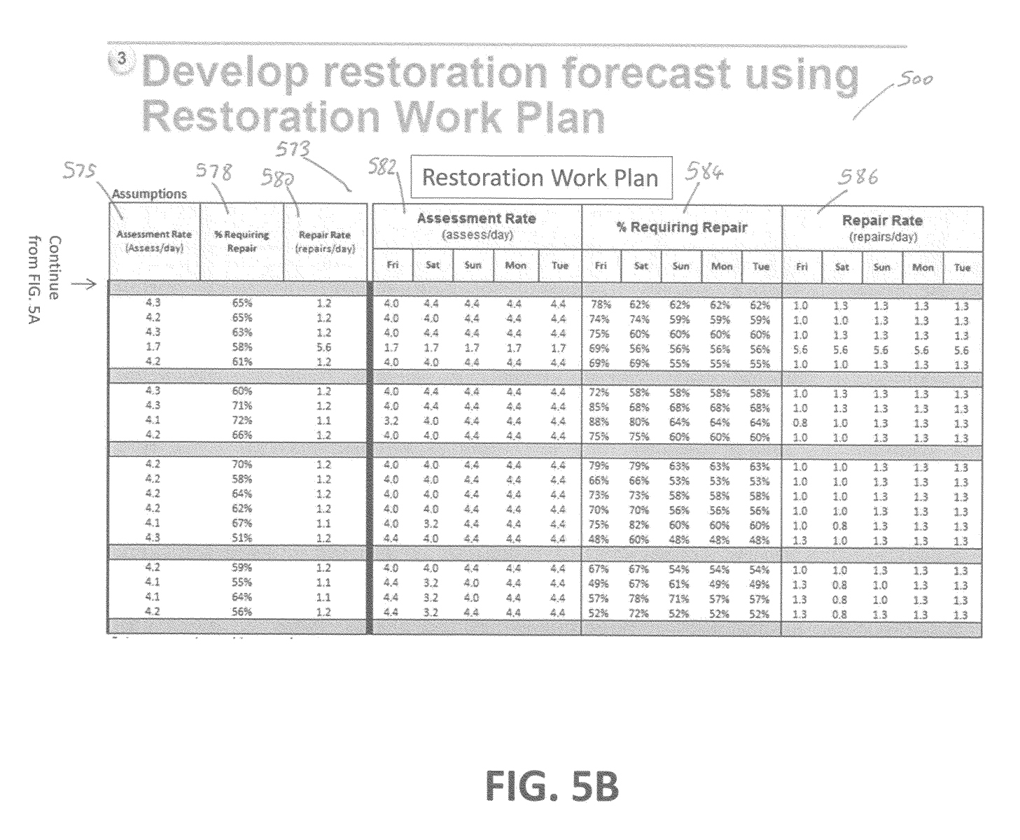

FIGS. 5A-5B provides an overview of a system and method for managing service restoration 10 helping assess current restoration forecasts using a restoration work plan 500 according to one embodiment of the invention. In some embodiments as shown, the system and method for managing service restoration 10 may help to assess current restoration forecasts by geographic area using a restoration work plan 500. In some embodiments, the service restoration management system 10 includes a work plan generator capable of providing a comprehensive restoration work plan 500 that incorporates SOPP data as well as real-time outage data (e.g., shown in the assessment data table 530), weather assumptions (relating productivity rates by storm type 510), and an analysis by division 520. Further, the restoration work plan 500 can provide automatic ETA's 565a and ETOR's 565b as well as easily comprehended visual displays of such information, associated remaining workload and total event cost. The restoration work plan 500 provides the status of restoration efforts and ETORs 565b and ETA's 565a based on the current conditions.

Some embodiments of the invention include an assessment data table 530 capable of displaying new outages 533, one or more resources assessment 536 based on those outages 533, any remaining assessments 539, and a total ETA 565a. Some embodiments of the invention include an assessment data table 530 capable of displaying a repair data table 545. Some embodiments of the invention include a repair data table 545 capable of displaying locations 550 (with the example shown in FIG. 5A being specific to New York locations, but data may be provided for any available region). In some embodiments, the repair data table 545 includes repair resources 555 available to complete a repair, work locations 560, as well as total ETOR 565b.

In some other embodiments, the total ETA 565a can display a day (i.e., the estimated day of the assessment as illustrated in the example of FIG. 5A) for each division 520. In some other embodiments, the total ETA 565a can display a time period. For example, in some embodiments, the total ETA 565a can display a period of more than one day. In some further embodiments, the total ETA 565a can display a time period of less than one day (for example, a morning or an afternoon period).

Some embodiments include an assessment data table 530 and a repair data table 545 that is displayed in a daily format 512. As shown in FIG. 5A, in some embodiments, the assessment data table 530 can display new outages 533, one or more resources assessment 536 based on those outages 533, any remaining assessments 539 in a daily format 512. Further, in some embodiments, the repair data table 545 includes displaying locations 550, repair resources 555 available to complete a repair, and work locations 560 displayed in a daily format 512. In the example illustrated in FIG. 5A, the daily format 512 comprises a display of five consecutive days. One of ordinary skill in the art will recognize that both the assessment data table 530 and the repair data table may include a daily format 512 that comprises a different number of days (i.e. less than or more than five consecutive days). Further, one of ordinary skill in the art will recognize that the daily format 512 does not have to display the same number of days for the assessment data table 530 and the repair data table 545. For example, in some embodiments, the assessment data table 530 and the repair data table 545 may each display data for a different number of days.

Some embodiments of the restoration work plan 500 can include at least one graphical display 570, capable of displaying data from the assessment data table 530 and/or the repair data table 545. For example, some embodiments of the restoration work plan 500 can include at least one graphical display 570 displaying remaining assessments 539 and repair work plans for each division 520 data. Moreover, in some embodiments, the type of data within the graphical display 570 can be selected based on a user preference. For example, a division displayed menu 590 can be used to select one or more divisions (and therefor display data related to only the selected divisions). Further, the resources displayed menu can be used to select a work plan.

In some embodiments, the at least one graphical display 570 can include an assessment work plan chart 571. In some embodiments, the assessment work plan chart 571 can include a new outages 533 and assessment resources 536 plotted in a bar-type chart and remaining assessments 539 plotted within the same chart using a line-type plot. As shown, the at least one graphical display 570 can also include a repair work plan chart 572. In some embodiments, the repair work plan chart 572 can include new work locations 550 and repair crews 555 plotted in a bar-type chart and remaining work locations 560 plotted within the same chart using a line-type plot.

Moreover, some embodiments of the restoration work plan 500 include productivity assumptions 128, 573. As shown in FIG. 5B, the assumptions data 573 can include historically derived assessment rate 575, % requiring repair 578, and repair rate 580 based on a daily assessment rate 582, a daily % requiring repair 584, and a daily repair rate 586. In some embodiments, the total ETA 565a is calculated and displayed by the system and method for managing service restoration 10 based at least in part on a historical productivity assumption data 573 where the productivity assumption includes a rate of assessment 575 and a rate of repair 580, as well as a percentage of outages requiring repair 578. For example, the ETOR 565b can be calculated based on the historical productivity assumption data 573 including a historical rate of assessment 575 and historical rate of repair 580, and percentage of outages requiring repair 578.

Some embodiments of the invention include ETA 565a and ETOR 565b updated substantially in real time. For example, in some embodiments, any data updated by the DSO SOPP 300 model can be reflected in the restoration work plan 500 substantially in real time. For example, in some embodiments, a value assignment of one of the severity category 352, 353, 354, 355, or 356 to one or more of data in the category columns 320 that may cause an update or modification of resource numbers. The resource numbers (for troublemen 340 and crews 345 for example) based on the calculated SO 330 and calculated CESO 335 may then be reflected in the restoration work plan 500 using at least one computer-implemented method of the service restoration management system 10 by processing at least one embodiment of the planning process 200 (e.g., using a system architecture 30 shown in FIG. 2B) to update at least one data value within the restoration work plan 500 substantially in real time. For example, in some embodiments, changes in any values of the DSO SOPP 300 model may be reflected substantially in real time in the assessment data table 530. Based on the assessment resources 536 and the remaining assessments 539, a total ETA 565a may be updated substantially in real time. For example, in some embodiments, a total ETA 565a may be updated in 0.5 seconds or less. Further, based on new work locations 550, repair crews 555, and remaining work locations 560, a total ETOR 565b may be updated in 0.5 seconds or less.

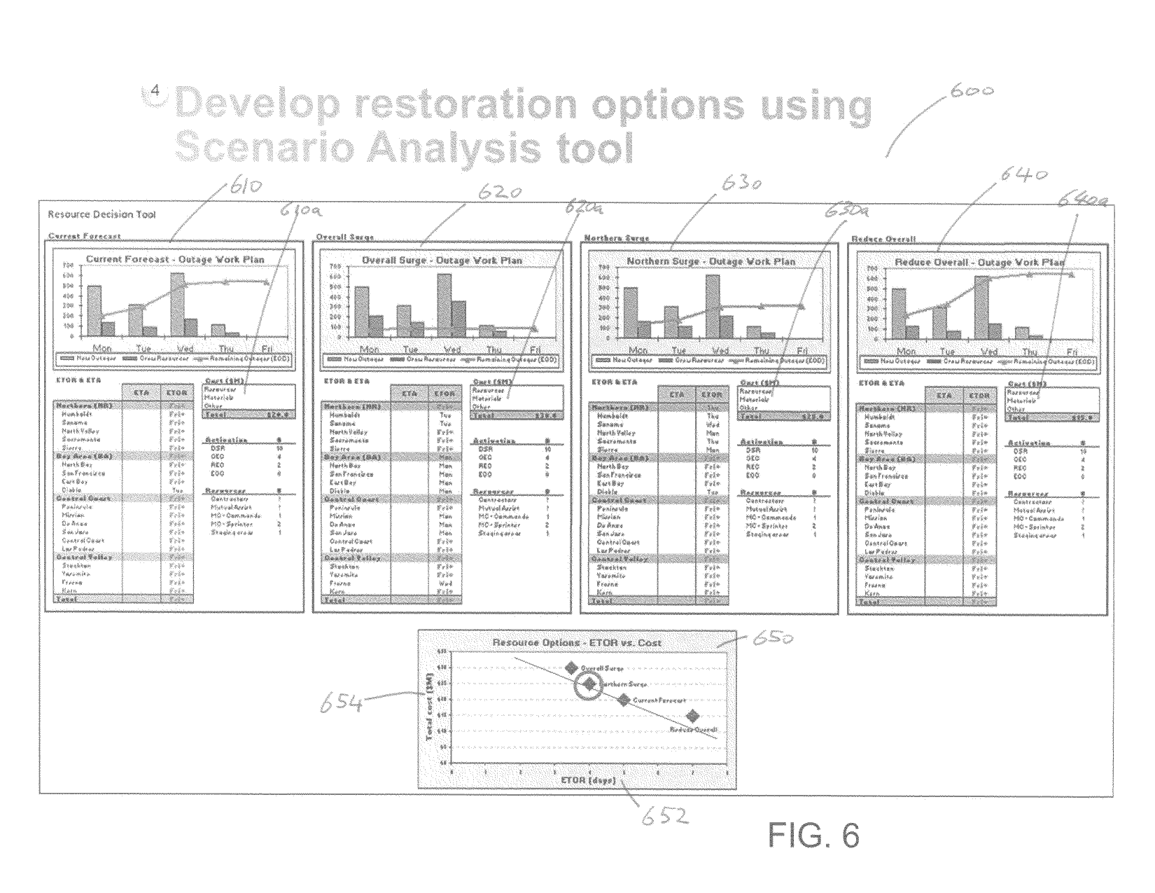

FIG. 6 provides one embodiment of a resource decision tool display 600 of a system and method for managing service restoration 10. In some embodiments, the resource decision tool display 600 may help to analyze various potential restoration scenarios based on expected restoration time and total event cost, according to one embodiment of the invention. In some embodiments, the service restoration management system 10 includes a scenario modeler 162 which enables analysis of various scenarios, including different weather patterns, resources dedicated to an event, productivity assumptions 128, geographic allocation of resources or extent of outage damage. These scenarios can be compared against each other based on total system cost 654 and total estimated time of restoration 652, and displayed within the resource decision tool display 600 to aid the selection of a desired restoration strategy. For example, as depicted in FIG. 6, the resource decision tool display 600 can include tabular data as well as graphically presented data including a current forecast outage work plan 610, an overall surge outage work plan 620, a northern surge outage work plan 630, and a reduce overall outage work plan 640. In some embodiments, one or more of the decision tool display 600 work plans 610, 620, 630, 640 include a graphical data display in addition to a graphical display 650 that can assist a user analyze various potential restoration scenarios based on expected restoration time and total event cost. For example, in some embodiments the resource decision tool display 600 can include financial data including for example plan costs, which may include a combination of resources, materials costs and other costs. As shown in FIG. 6, in some embodiments, the current forecast outage work plan 610 can include a cost 610a, the overall surge work plan 620 can include a cost 620a, the northern surge work plan 630 can include a cost 630a, and the reduce overall outage work plan 640 can include a cost 640a. The resource decision tool display 600 can include an ETOR versus cost graph 650 comparing the ETOR 652 versus total cost ($M) 654 for the current forecast outage work plan 610, the overall surge work plan 620, the northern surge work plan 630, and the reduce overall outage work plan 640.

FIG. 7 is an overview of a system and method for managing service restoration 10 helping determine an optimal ETOR target (lowest total cost response 750) to minimize total event cost 730 according to one embodiment of the invention. In some embodiments, the service restoration management system 10 provides a visual display 700 such as the example shown in FIG. 7 which enables an ETOR target (i.e., restoration time 710) to be set which minimizes the total event cost (i.e., total system cost 720) to customers and the utility. Many prior art models only analyze direct utility cost which do not take into account the full negative impact or costs to the system caused by outages. Minimizing total system cost 720 rather than just utility costs considers costs borne by both the utility and customer. For example, the visual display 700 includes an event cost model graph 700 that includes data plotted as a function of restoration time 710 and total system cost ($M) 720. As shown, the event cost model graph 700 can include a plot of total system cost plot 730 as well as a plot of societal cost 740 and utility cost 735. Further, FIG. 7 is shown to be capable of showing the lowest total cost response (approximate center of circle 750) can be identified by the intersection of the societal cost 740 and the utility cost 735 (shown in the total system cost plot 730 as a shallow minimum within the circle 750). Visualization of data produced by at least one method of the system and method for managing service restoration 10 allows a user to quickly determine at what point a customer pays the additional cost and when the utility provider pays the additional cost.

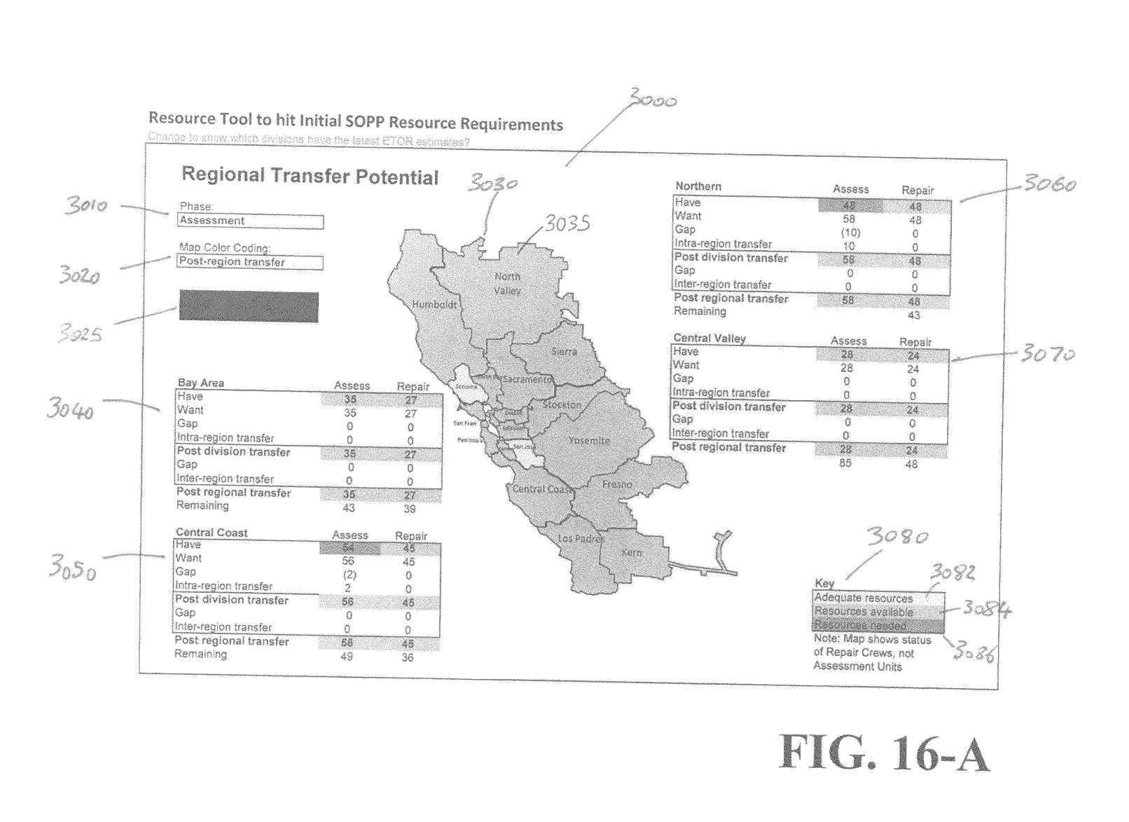

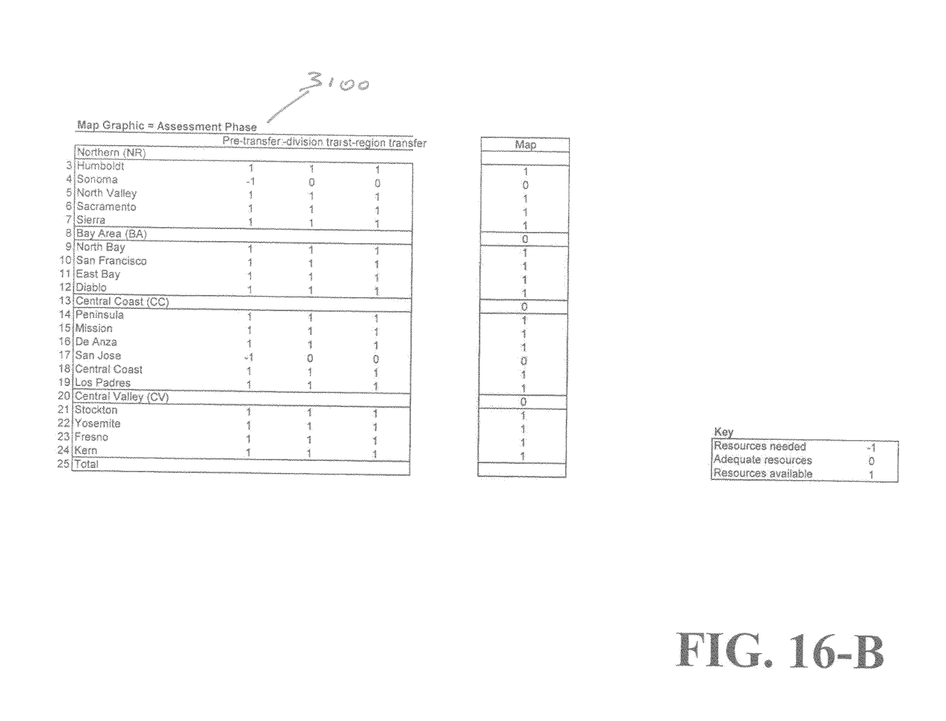

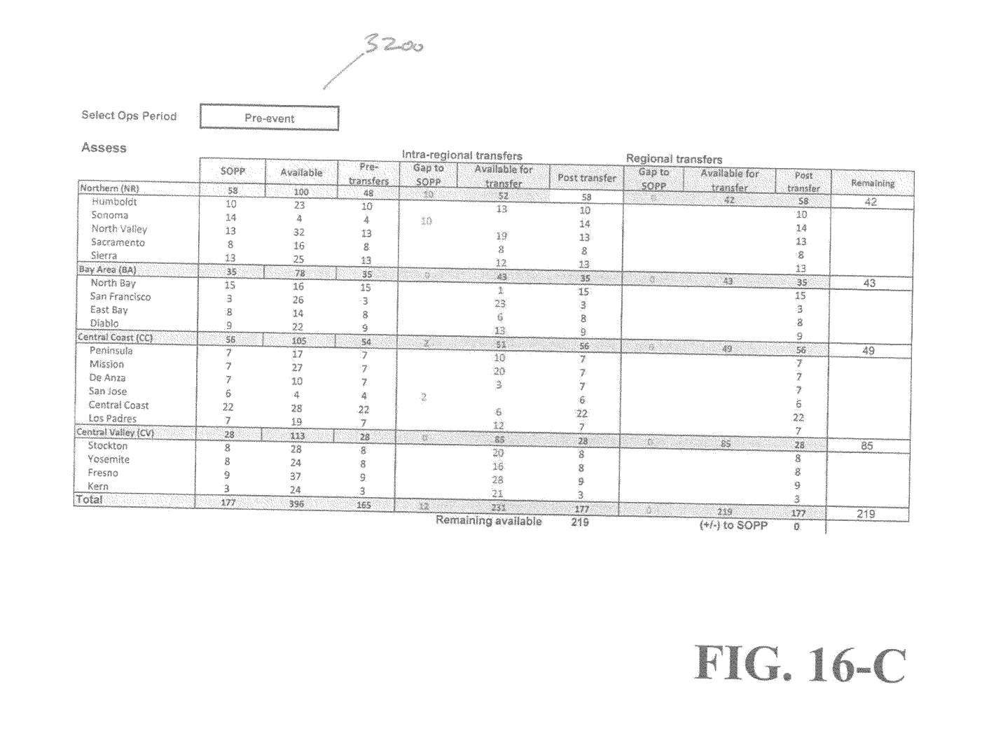

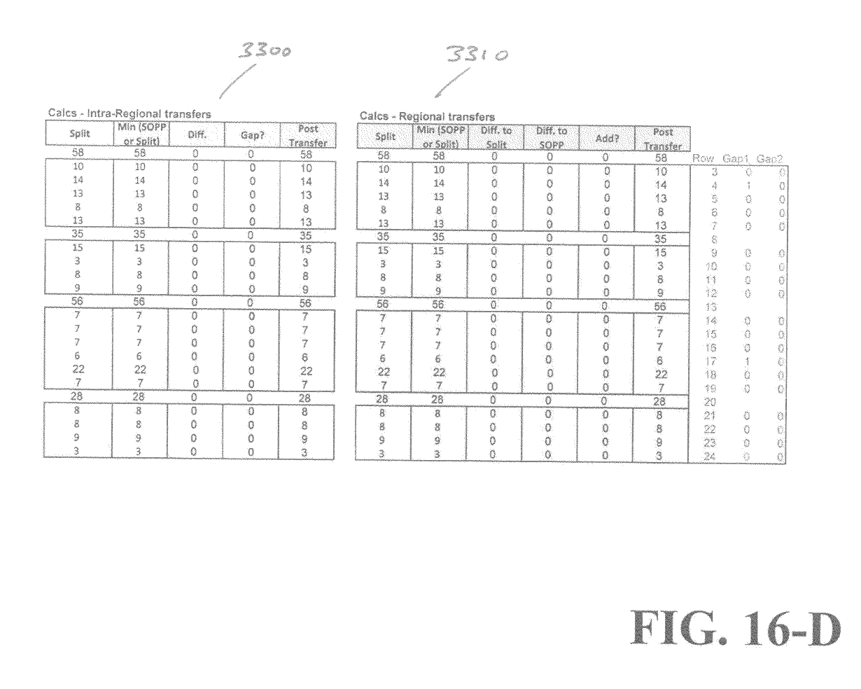

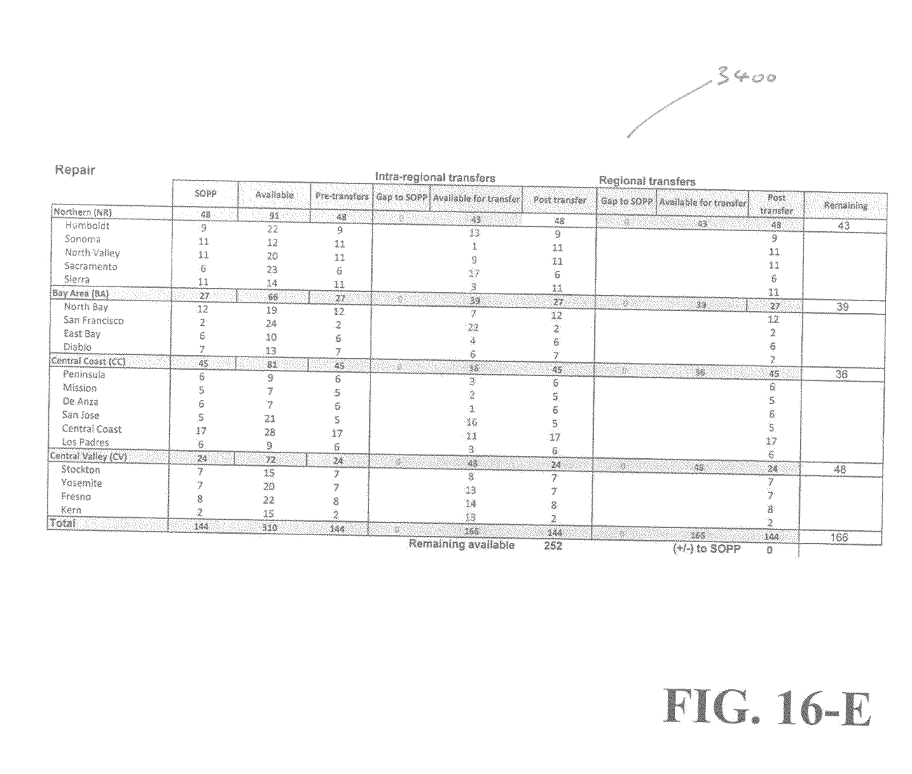

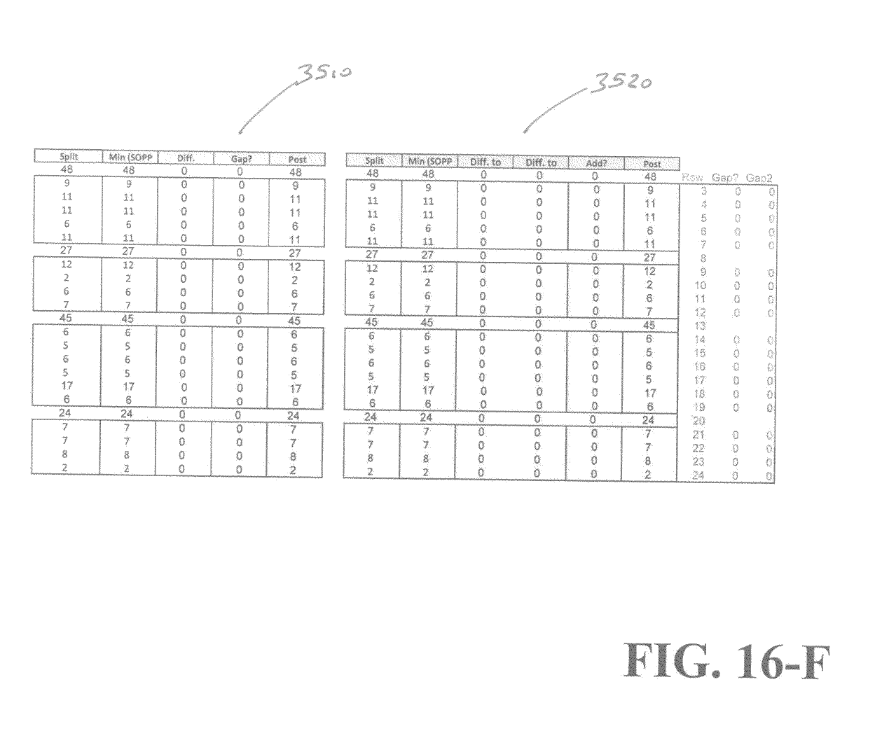

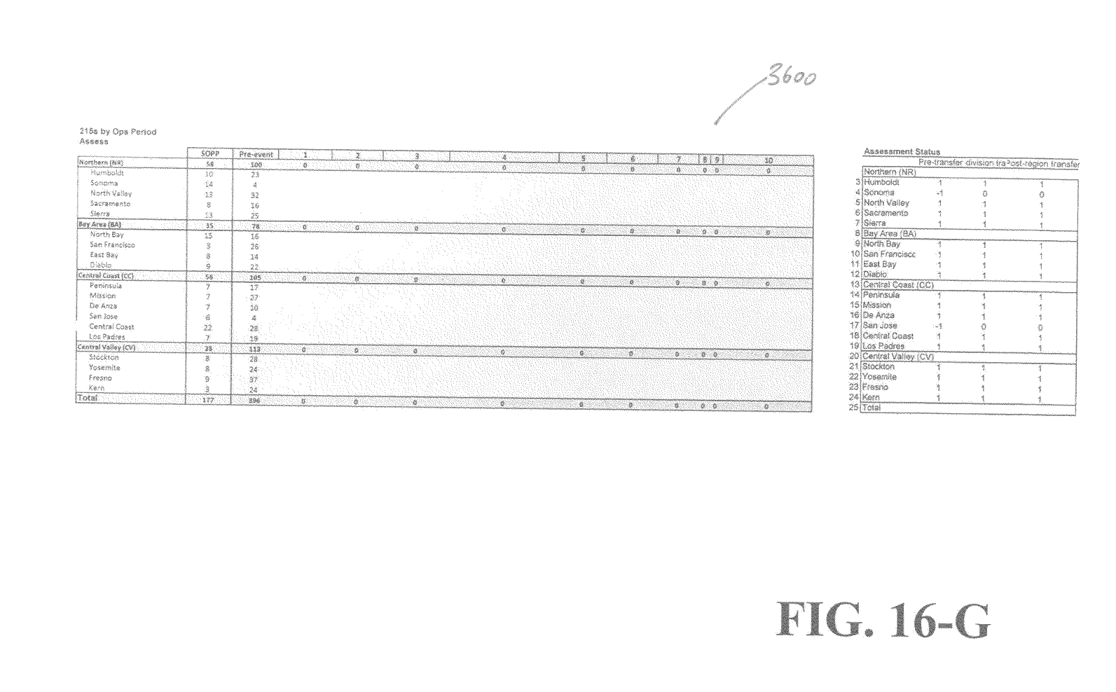

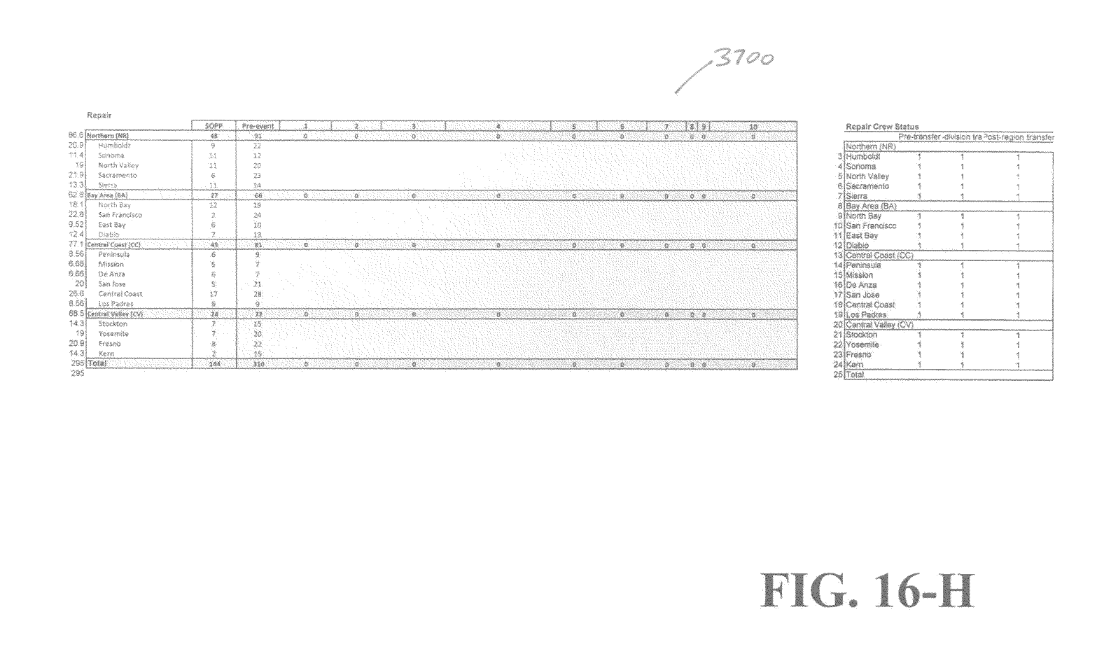

FIG. 8 is an overview of a system and method for managing service restoration 10 helping identify resource gaps and develop a resource transfer strategy according to one embodiment of the invention. In some embodiments, the service restoration management system 10 includes the resource transfer module 800 to clearly identify resource gaps by desired geographic region. A resource gap is the difference between current available resources and the total number of resources desired as outlined in the restoration strategy. Once the resource gaps are identified, the service restoration management system 10 can help develop the desired or optimal resource transfer analysis 166 based upon location of additional available crews 345, resource and transfer costs and transfer time. As shown in FIG. 8, some embodiments of the resource transfer module 800 include a resource supply vs. demand chart 810 (with Bay area, California data in this example) from which data can be used within a regional transfer data display 850 (see also FIG. 16A). The resource supply vs. demand chart 810 shows data 805 plotted as a function of work locations 815 versus the marginal cost 820, and shows the resource type as a function of category, showing cat 3(840), cat 4(845) and cat 5(848) regions along the work locations 815 axis. In some embodiments as shown, the resources versus cost curve 805 can comprise local resources 825 up through a cat 3(840) event and to around a cat 4(845) event. Further, as shown, the cost curve 805 can comprise transfer resources 830 beyond a cat 4(845) event up to and past a cat 5(848) event. Moreover, in some embodiments, a work locations forecast 835 can be shown, indicating a forecast demand (work locations 815) and marginal cost at the intersection of the cost curve 805 (comprising transfer resources 830) with the work locations forecast 835.

FIG. 9 is an overview of a system and method for managing service restoration helping compare divisional ETOR forecasts 900 according to one embodiment of the invention. In some embodiments, the service restoration management system 10 compares ETOR forecasts 922 by desired geographic region (i.e. divisions) providing insight into whether resources should be transferred based on actual progress in the field. Any such transfers are then reflected on the overall restoration work plan 500. As depicted in FIG. 9, some embodiments of the divisional ETOR forecasts 900 includes a repair work plan chart 910 (as an example, illustrating data for Yosemite, California), and a repair work plan chart 950 (as an example, illustrating data for the California central coast). The data for each chart can include new work locations 912 and the number of repair crews 914 plotted in a bar-chart format, as well as a plot of remaining work locations 916. In some embodiments, illustrating data in this format allows a user to identify transfers 920, compare estimated time of restoration across divisions 922, consider resource transfer into divisions with need 924, as well as to reflect resource transfers in restoration work plan 926.

In some embodiments, the service restoration management system 10 provides other reporting components 1000, including, without limitation, the historical cost estimate charting tool 1100, and service restoration management system dashboards 1200, 1300, 1400 relating to overall resources, overall performance and current restoration status. For example, the other reporting components 1000 may include a resource dashboard 1200, an event summary dashboard 1300, and a current status dashboard 1400 discussed below.

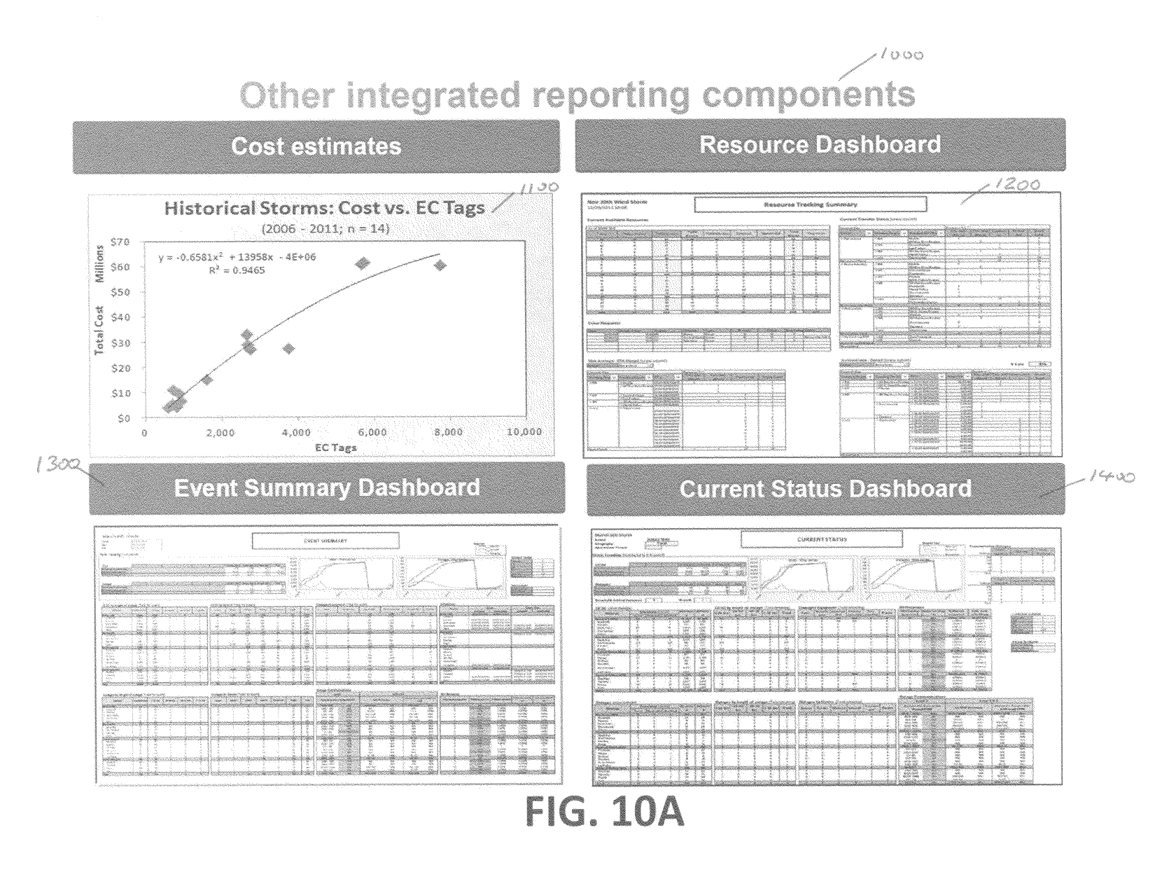

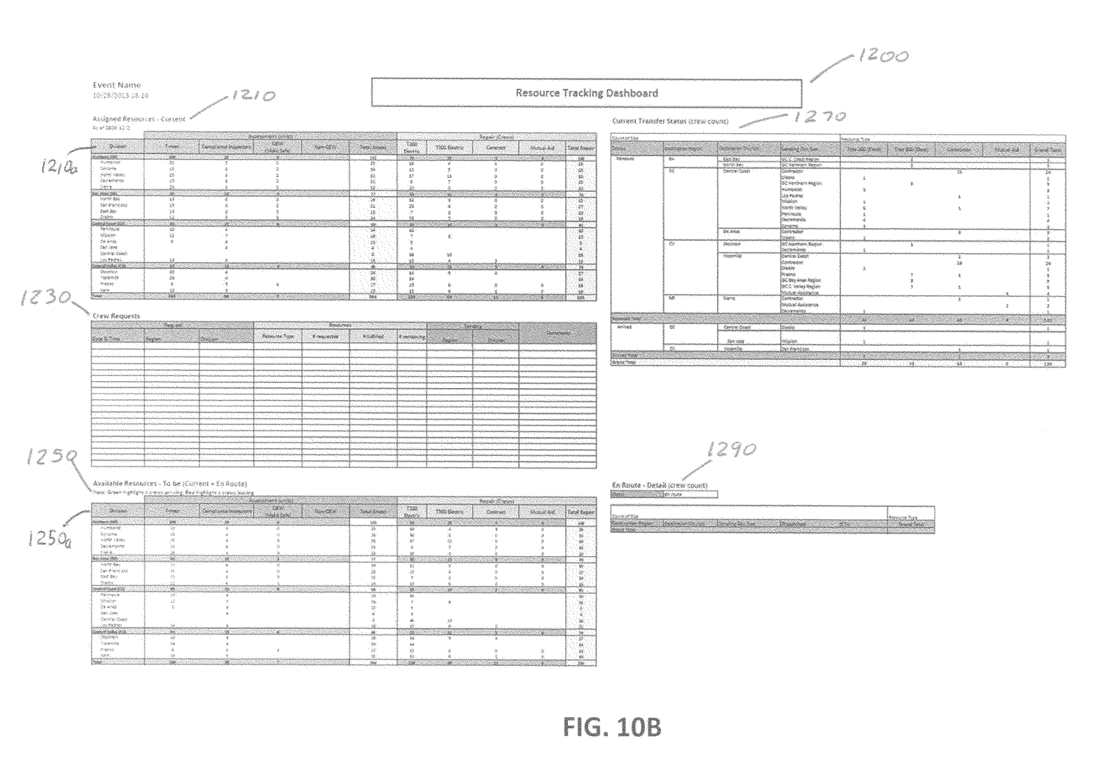

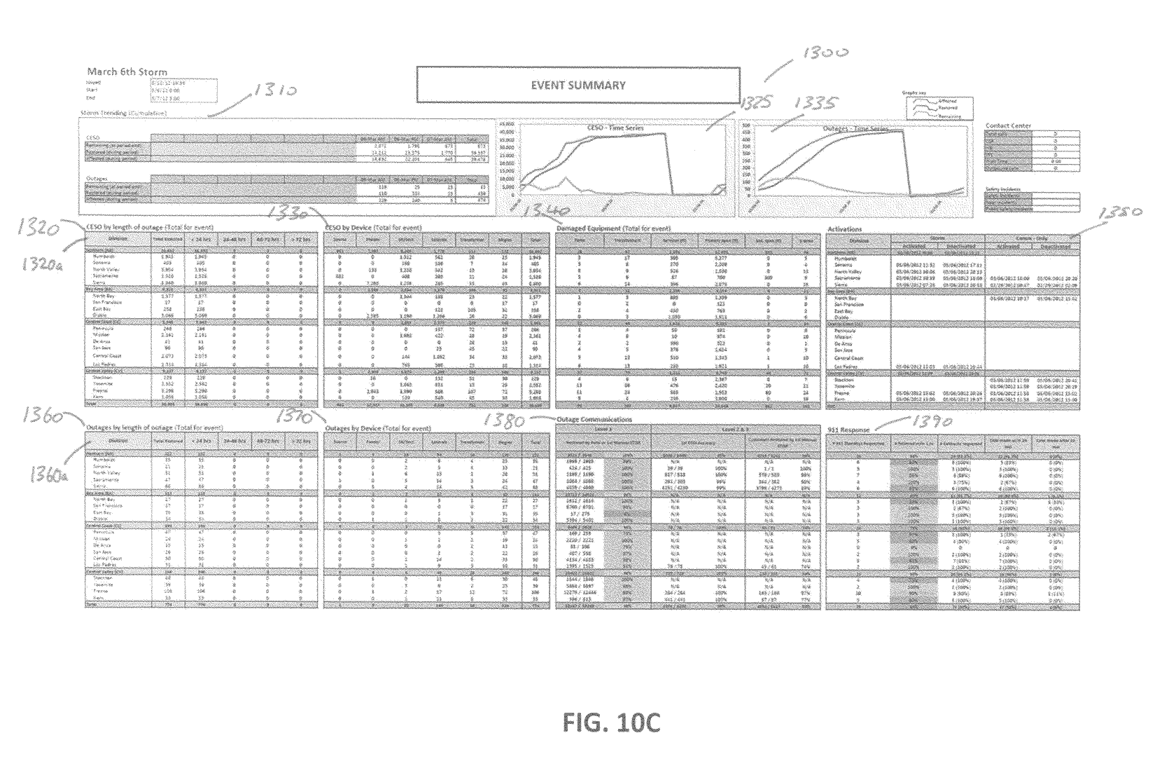

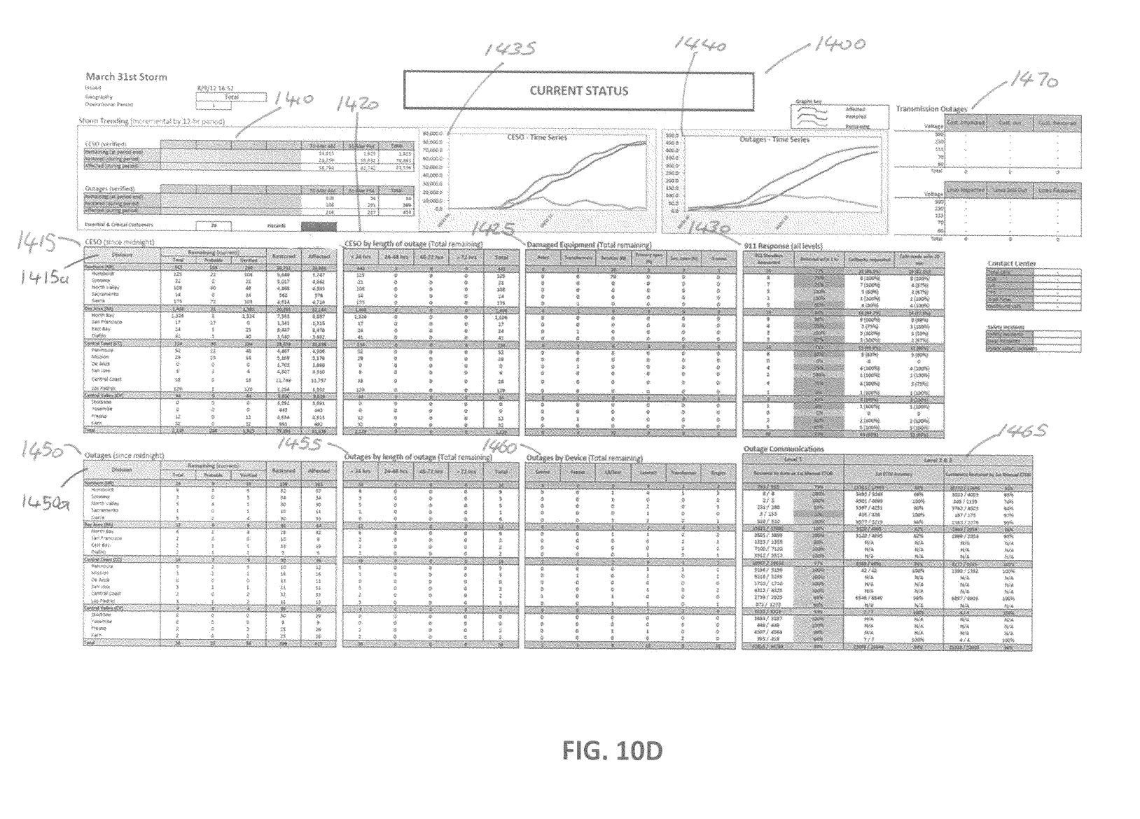

Some embodiments of the invention can enable a user to track one or more resource assets available to the service restoration management system 10. For example, FIG. 10B illustrates a resource tracking dashboard 1200 generated by the system and method for managing service restoration 10 according to one embodiment of the invention. The resource tracking dashboard 1200 can display a currently assigned resources table 1210, a crew count table 1270 and a crew en-route detail table 1290. Some embodiments can enable a user to plan for restoration management (i.e., assess and track resources available for a future restoration work plan 500), and therefore can provide strategic resource asset information available to the service restoration management system 10. For example, in some embodiments, the resource tracking dashboard 1200 can provide a crew request table 1230, as well as a “to be available” resources table 1250. Moreover, any data displayed within the resource tracking dashboard 1200 can be provided as a function of division, as represented by division columns 1210a, 1250a.

Some embodiments of the service restoration management system 10 can enable a user to display an event summary. For example, FIG. 10C illustrates an event summary dashboard 1300 generated by the system and method for service restoration management 10 according to one embodiment of the invention. The event summary dashboard 1300 can include a storm trending data table 1310 as well as various SO 330 and CESO 335 related data tables and plots covering data related to the length of time since the outage, equipment affected, communications amongst other information. For example, as shown in FIG. 10C, the event summary dashboard 1300 can include a CESO by length of outage 1320, a CESO time series plot 1325, a CESO by device table 1330, an outages time series plot 1335, a damaged equipment table 1340, and an activations table 1350. Further, the event summary dashboard 1300 generated by the system and method for service restoration management 10 can also include outage data including outages by length of outages table 1360, outages by device table 1370, and an outage communications table 1380. Further, in some embodiments, information related to emergency responses to one or more event outages can be displayed including a 911 response table 1390. Moreover, any data displayed within the event summary dashboard 1300 can be provided as a function of division, as represented by division columns 1320a, 1360a.

Some embodiments of the service restoration management system 10 can enable a user to display a current status. For example, FIG. 10D illustrates a current status dashboard 1400 generated by the system and method for managing service restoration 10 according to one embodiment of the invention. The current status dashboard 1400 can include a storm trending data table 1410 as well as various CESO 335 data tables and plots including CESO data 1415, a CESO time series plot 1435, a CESO by length of outage 1420, and a damaged equipment table 1425. Further, the event summary dashboard 1400 generated by the system and method for service restoration management 10 can also include outage data including outages 1450, outages by length of outage 1455, outages by device 1460, and outage communications 1465. In some embodiments, other outage data can be displayed including transmission outages 1470. Moreover, information related to emergency responses to one or more event outages can be displayed including a 911 response table 1430. Further, outage data can be graphically displayed as an outages time series plot 1440 within the current status dashboard 1400. Moreover, any data displayed within the current status dashboard 1400 can be provided as a function of division, as represented by division columns 1415a, 1450a.

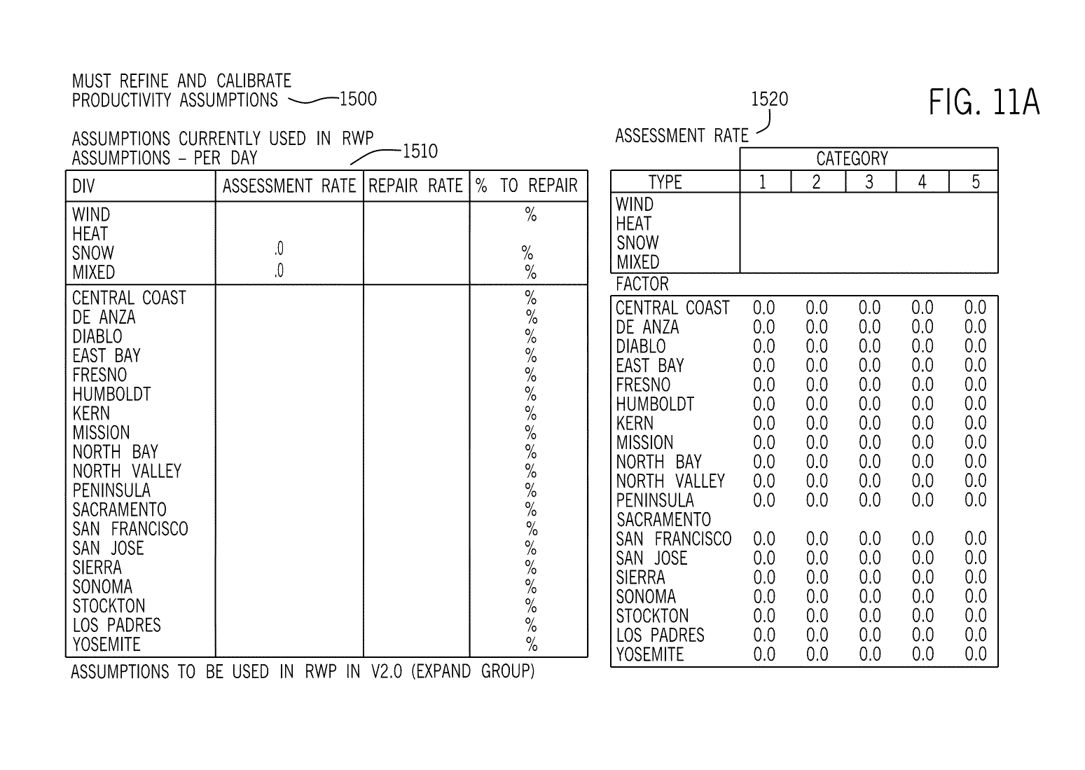

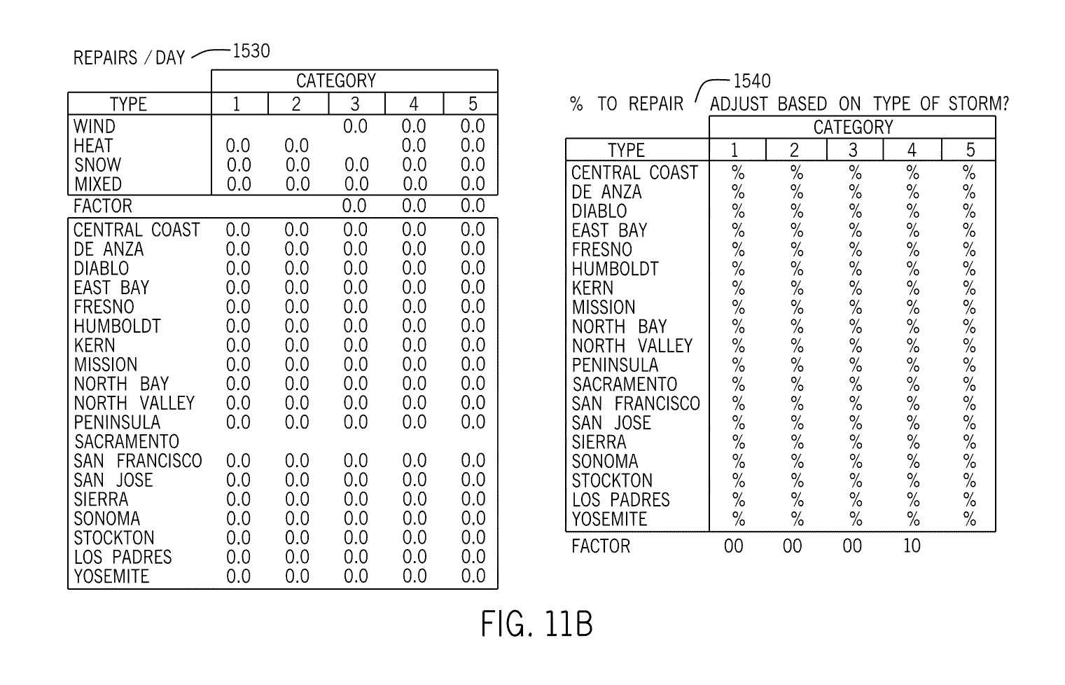

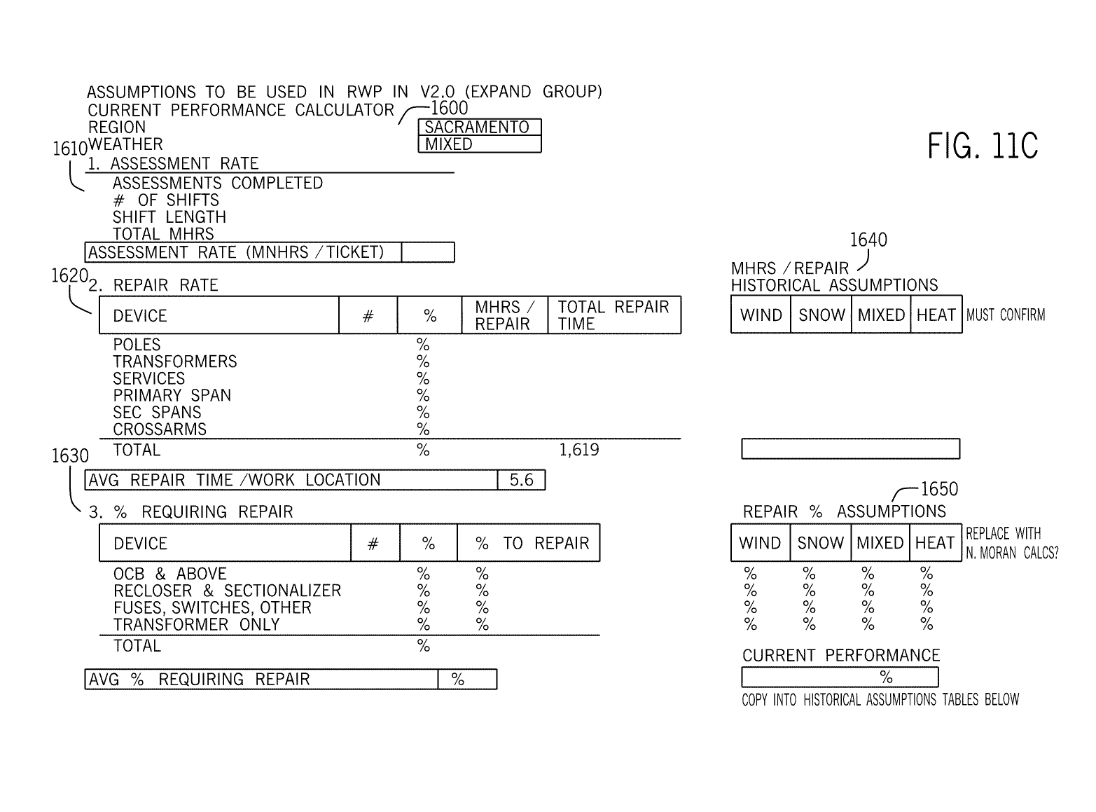

As described earlier with respect to the disclosure of FIG. 5B, some embodiments of the restoration work plan 500 include productivity assumptions data 573 that may comprise a historically derived assessment rate 575, % requiring repair 578, and repair rate 580 based on a daily assessment rate 582, a daily % requiring repair 584, and a daily repair rate 586. In some embodiments, the service restoration management system 10 provides the ability to list, describe and prioritize productivity assumptions used in the restoration work plan as shown in FIGS. 11-A through 11-C. In some embodiments, these assumptions can be used as inputs 120 to the system 10 and can be changed as needed to improve the accuracy of the system 10. The assumptions can be based on historical productivity performance from past events and can be calculated based on type of event, including snow, heat, wind and mixed weather events. Additionally, assumptions can be tailored by geographic region based on current conditions and productivity, if different than historical performance. For example, FIG. 11A illustrates a productivity assumptions data display 1500. In some embodiments, the display 1500 can include assumptions per day table 1510 and an assessment rate table 1520. Some embodiments can include a productivity based on repairs. For example, FIG. 11B illustrates a repairs per day table 1530 in addition to a % to repair table 1540.

Some embodiments include a current performance calculator display 1600. As shown in FIG. 11C, in some embodiments, various performance statistics can be reviewed by a user including for example the assessment rate 1610, the repair rate 1620, and the % requiring repair 1630. Historically derived data can be displayed within the current performance calculator display 1600 including historical assumptions 1640, as well as repair % assumptions 1650 based on any specific weather mix.

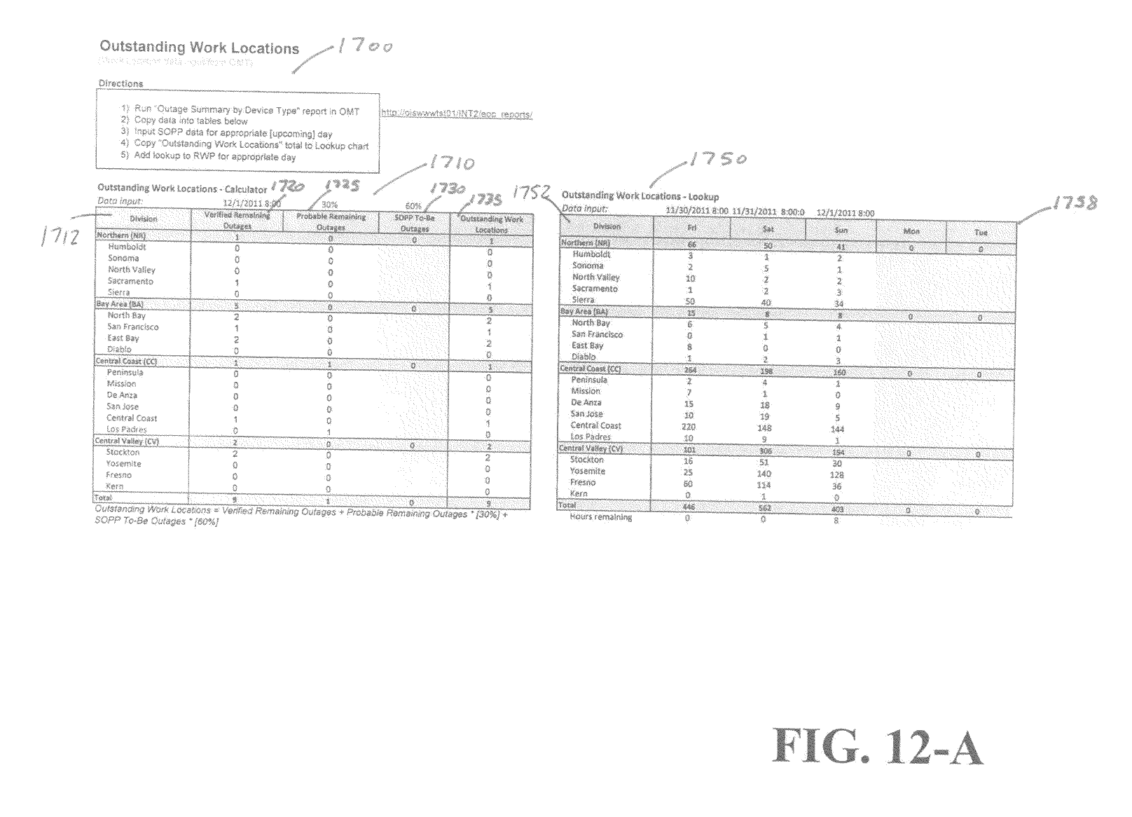

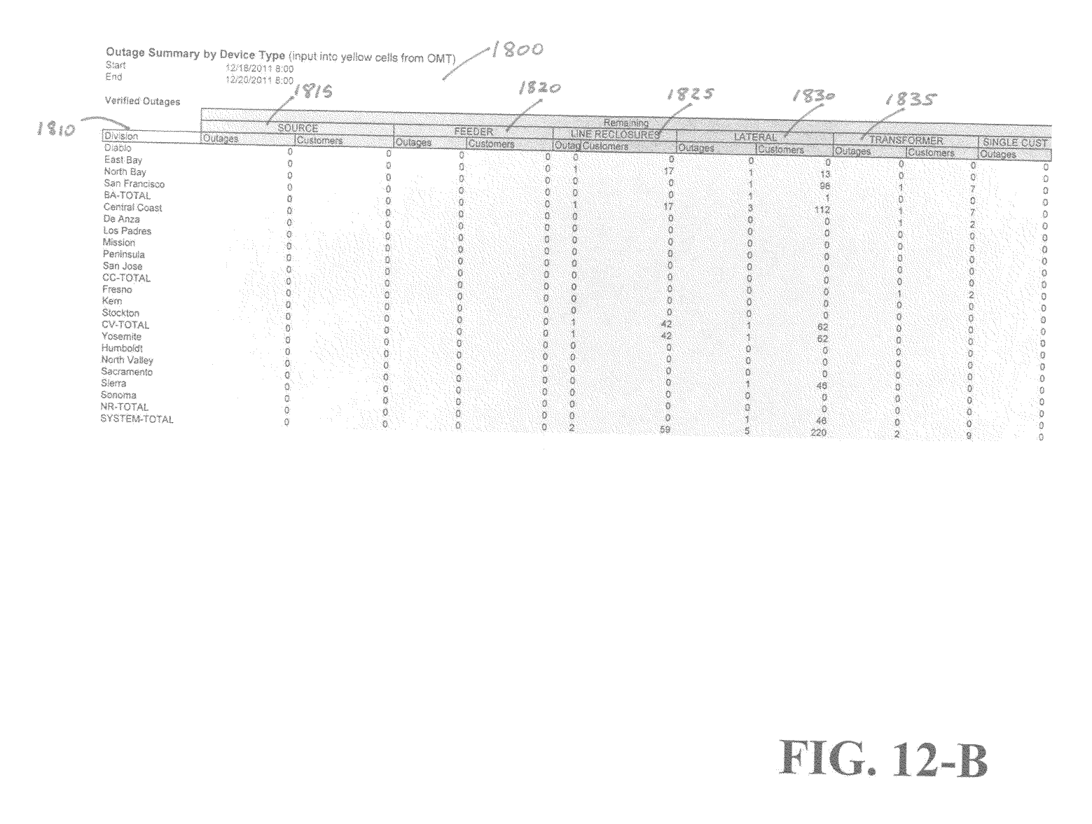

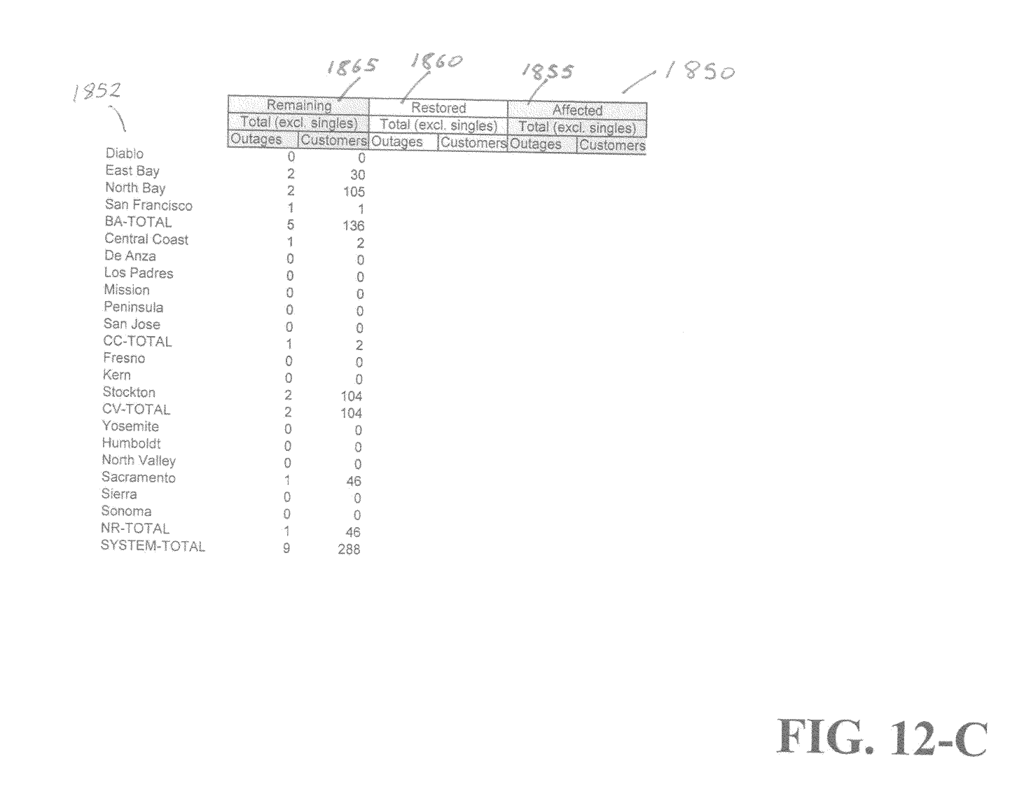

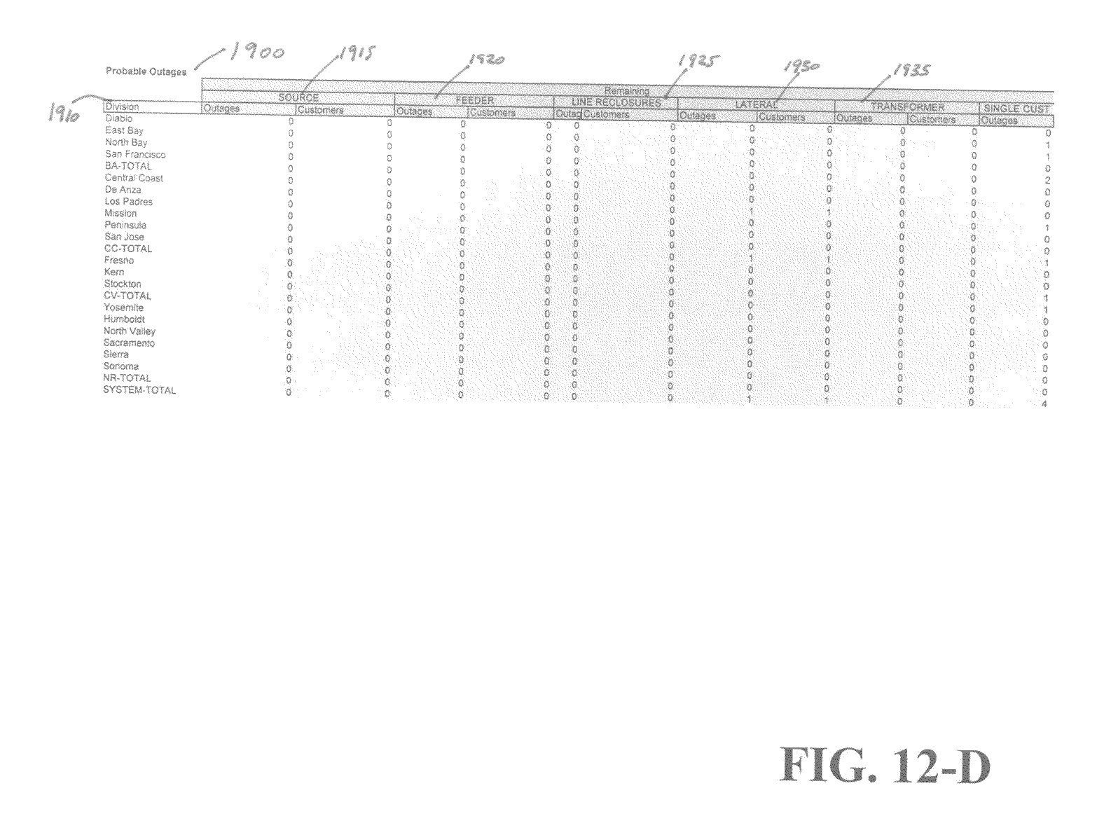

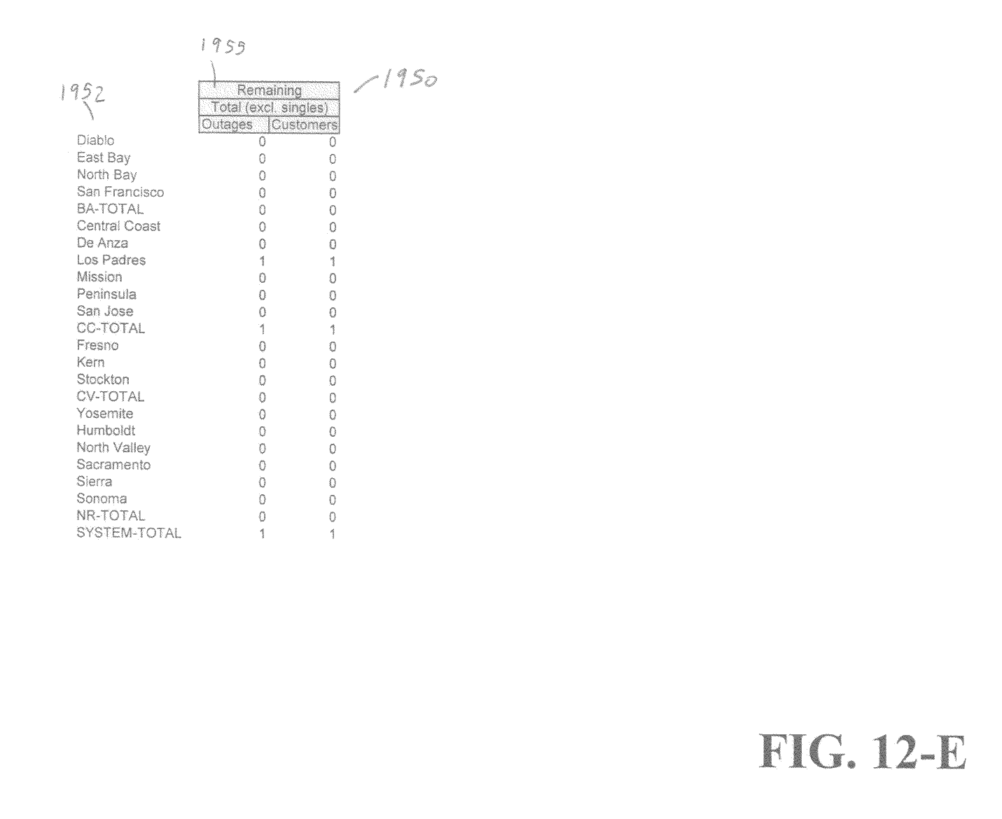

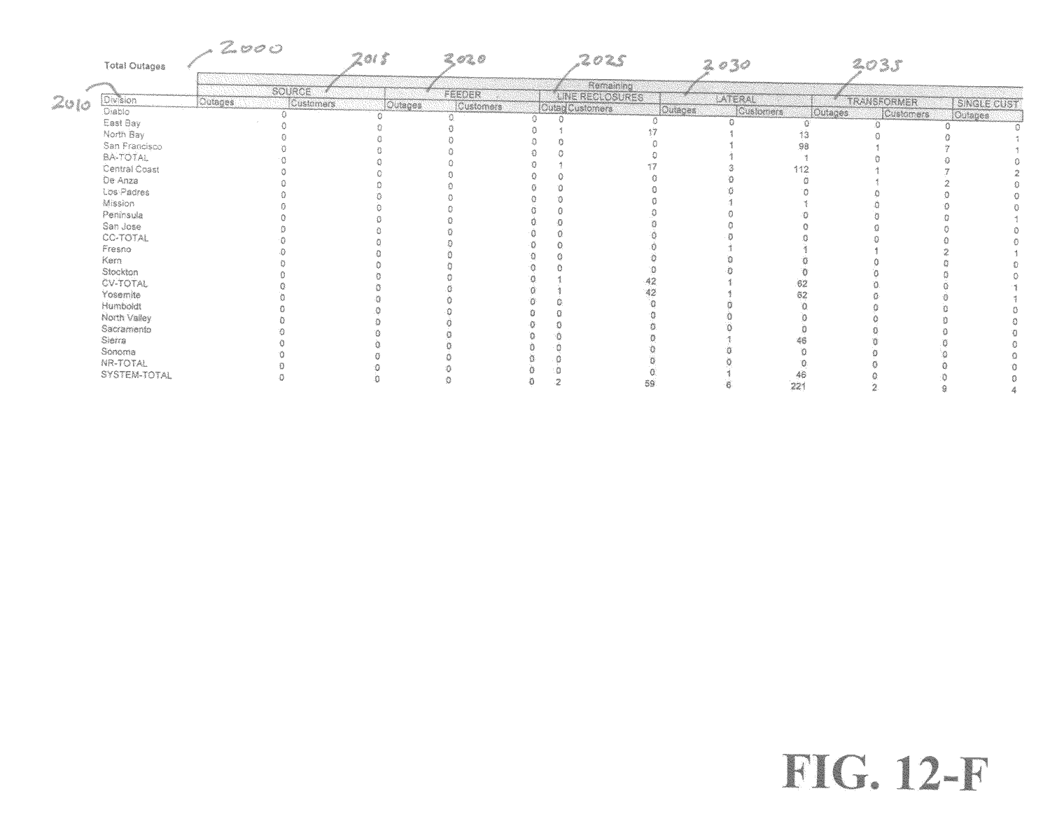

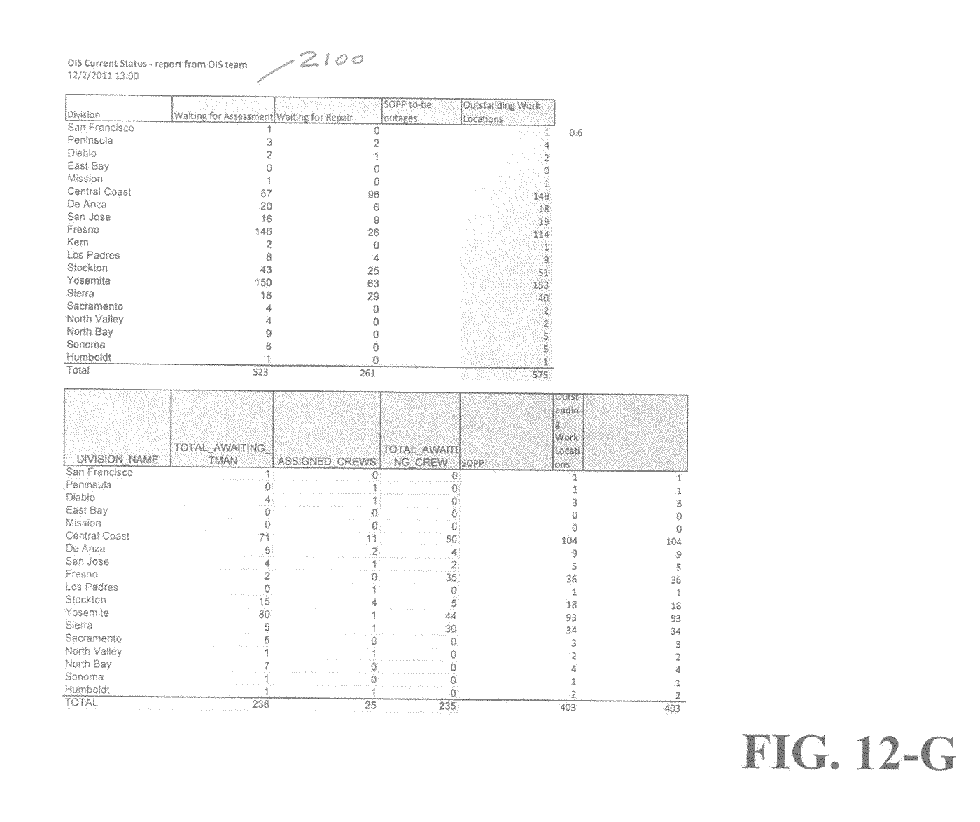

In some embodiments, the system and method of the service restoration management system 10 can utilize outage summaries including current outage and customer counts. For example, as described earlier with respect to the restoration work plan system 100, in some embodiments, data inputs 120 can be used (e.g., pre-event data 122 can include outages and work locations (SOPP) 124, resources 126, as well as historical productivity assumptions 128). FIGS. 12A-G are an example of the current outage and customer counts that can be used as feeds for the calculation of ETOR 565b estimates in the restoration work plan 500, according to one embodiment of the invention. In some embodiments, outstanding work locations for the desired day can be calculated, as shown in FIGS. 12-A through 12-G. These locations can be integrated automatically or manually into the restoration plan 500 as desired. FIG. 12A for example illustrates one embodiment of the service restoration management system 10 showing an outstanding work locations display 1700 including an outstanding work locations calculator 1710 providing outstanding work location by division 1712, and an outstanding work locations lookup 1750 providing outstanding work location by division 1752. The work locations calculator 1710 can include a verified remaining outages data column 1720, a 30% probably remaining outages column 1725, and an SOPP to-be outages column 1730. The outstanding work location by division 1712 can also include an outstanding work locations column 1735 which in some embodiments, includes data calculated from the verified remaining outages data column 1720, a 30% probably remaining outages column 1725, and an SOPP to-be outages column 1730.

In some embodiments, the system and method of the service restoration management system 10 can utilize outage by device type for verified outages. For example, FIG. 12B includes an outage summary by device type display 1800 as a function of division 1810. As shown, data columns can be for outages and customers for numerous device types including source 1815, feeder 1820, line re-closures 1825, lateral 1830 and transformer 1835 devices. In some embodiments, the system and method of the service restoration management system 10 can utilize outage status data. For example, FIG. 12C shows an outage summary by outage summary display 1850, including remaining 1865, restored 1860 and affected 1855 data columns shown for division 1852.

In some embodiments, the system and method of the service restoration management system 10 can utilize probable outages data. For example, FIG. 12D shows a probably outages display 1900 as a function of division 1910. As shown, data columns can be for outages and customers for numerous device types including source 1915, feeder 1920, line re-closures 1925, lateral 1930 and transformer 1935. FIG. 12E shows a probably outages display 1950 showing a remaining 1955 probably outages data column for division 1952.

In some embodiments, the system and method of the service restoration management system 10 can utilize total outages data. For example, FIG. 12F shows a total outages display 2000. As shown, data columns can be for outages and customers for numerous device types including source 2015, feeder 2020, line re-closures 2025, lateral 2030 and transformer 2035 data columns for division 2010.

In some embodiments, the system and method of the service restoration management system 10 can utilize current status outages data. For example, FIG. 12G shows a current status display 2100.

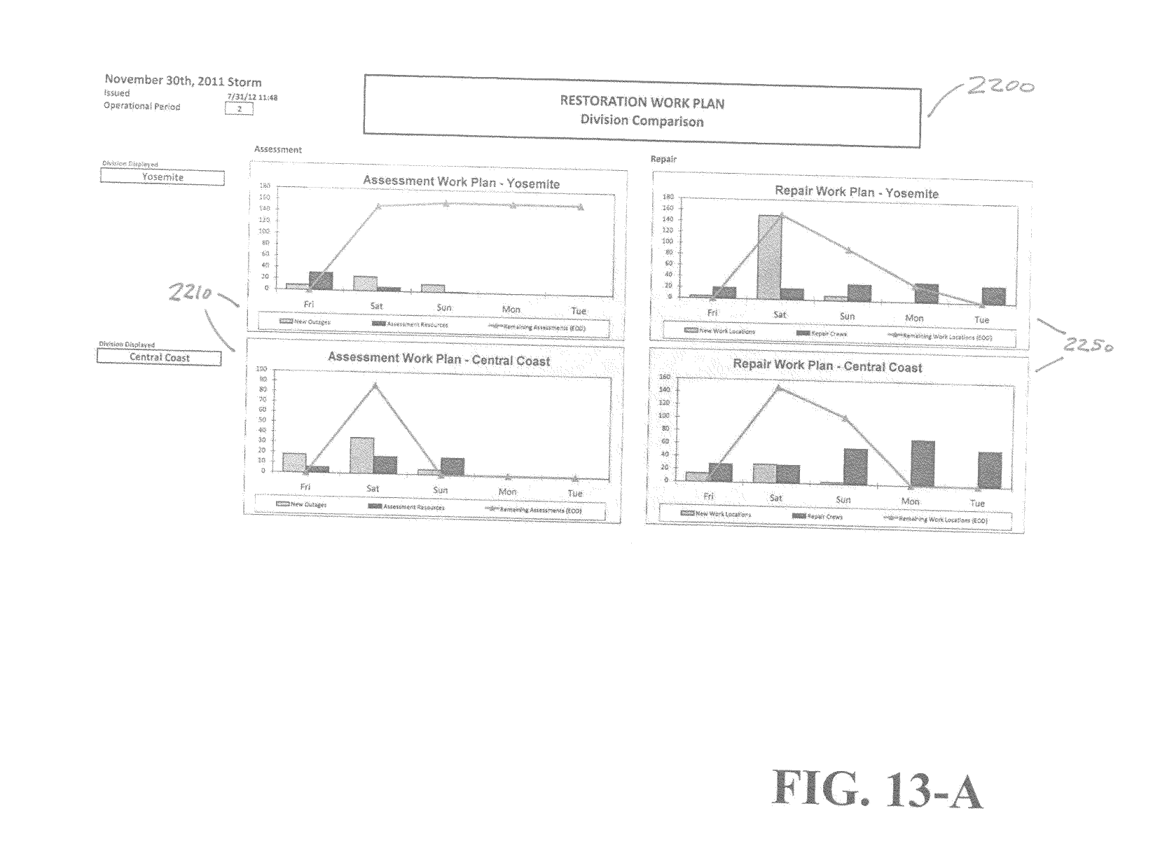

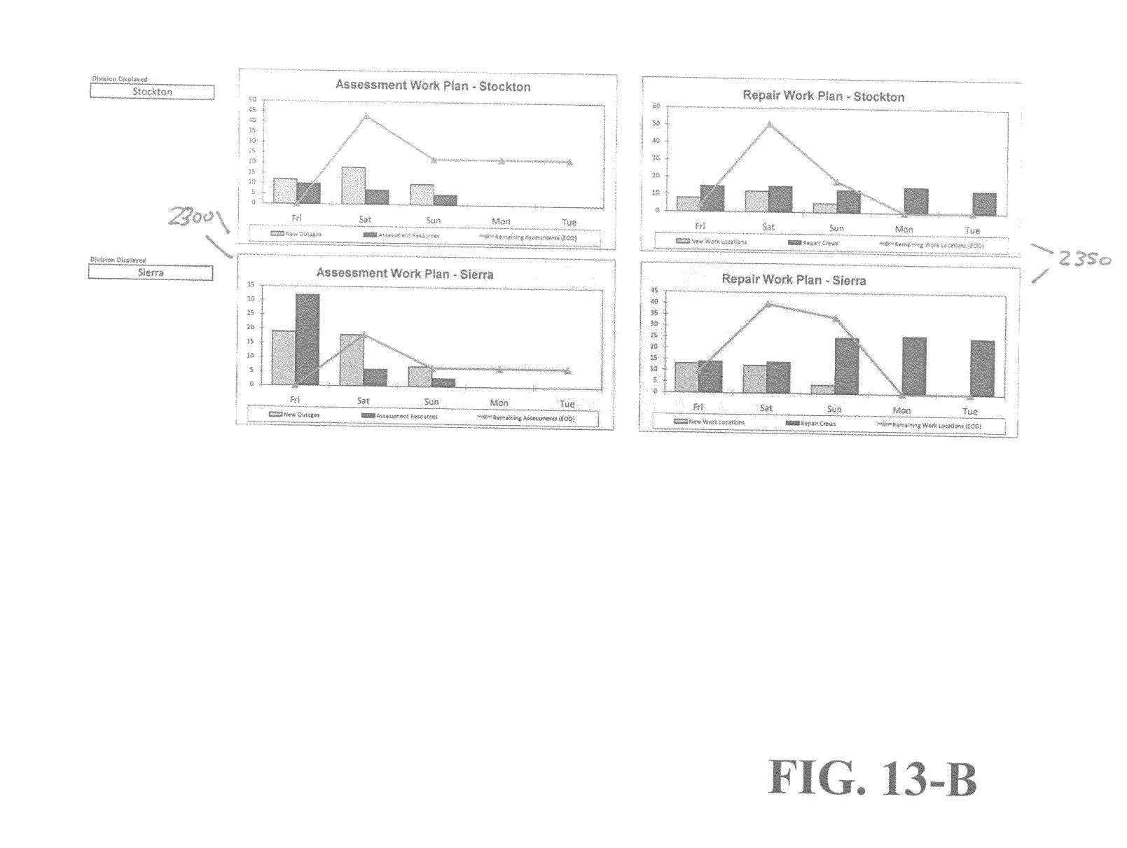

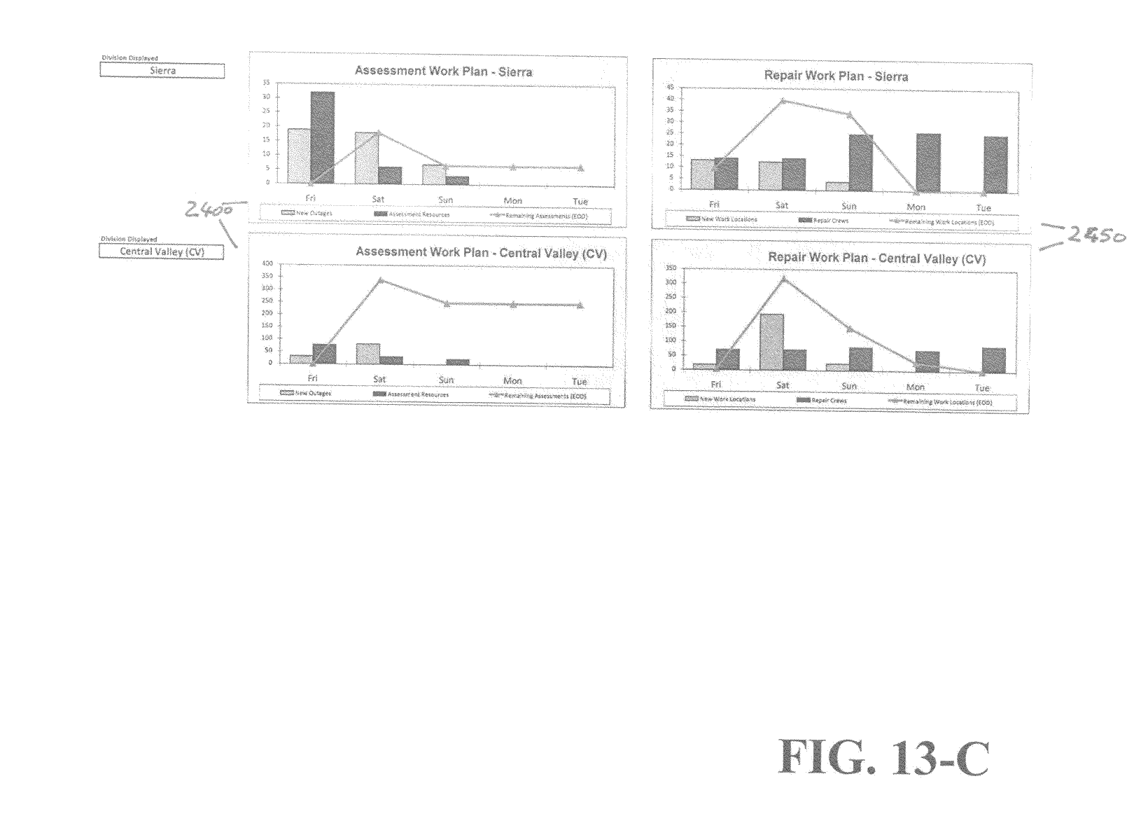

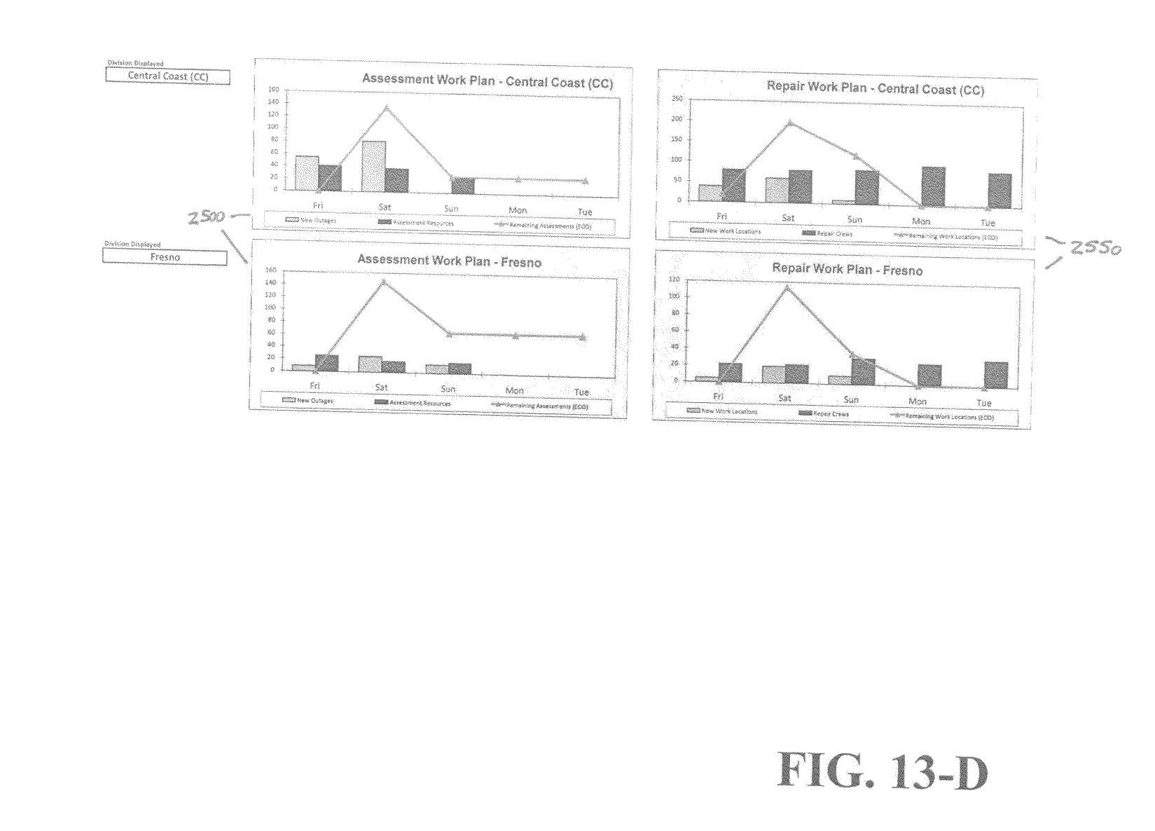

In some embodiments, the service restoration management system 10 can include analytical modules that receive inputs regarding restoration work plans for different geographic regions and produce charts that enable ready comparison between the regions as shown in FIGS. 13A through 13D. As noted earlier in relation to the restoration work plan system 100, in some embodiments, a user may have access to various information generated as part of the restoration work plan 140 including outages and work locations 142, and remaining assess and work locations 146. These comparisons are useful in identifying geographic areas that are estimated to not restore customers by a targeted restoration date, and can trigger manual or automatic resource transfers to balance workload and achieve the utility's goals.

For example, FIG. 13A shows one example of a restoration work plan display 2200 that includes assessment work plan 2210 for two different divisions and repair work plan 2250 for each division. FIG. 13B shows assessment work plan 2300 for two other divisions, as well as repair work plan 2350 for each division. FIG. 13C shows an assessment work plan 2400 for two divisions and an associated repair work plan 2450. Further, FIG. 13D shows an assessment work plan 2500 for two divisions and a repair work plan 2550 showing a repair work plan for each division.

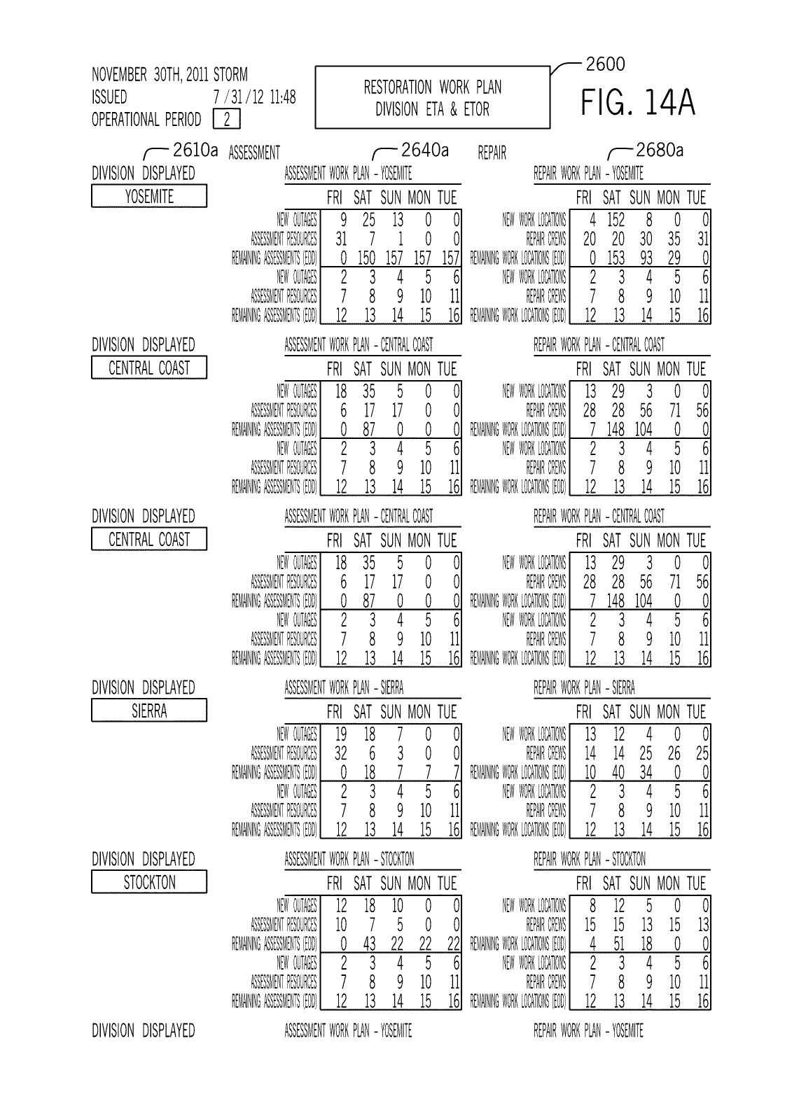

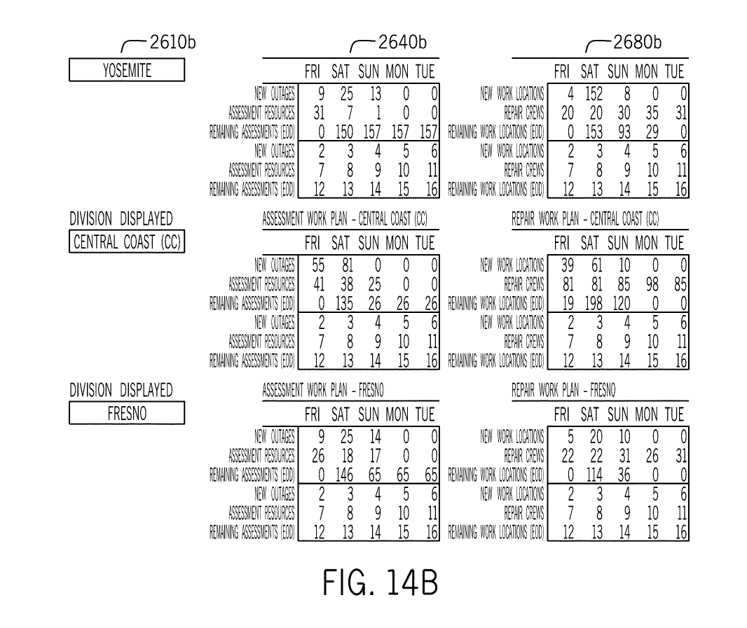

In some embodiments, the service restoration management system 10 can include analytical modules that receive inputs regarding restoration work plans for different geographic regions and produce ETA and ETOR information for those regions. Some embodiments of the restoration work plan system 100 may allow a user to gain access to various information generated as part of the restoration work plan 140 including ETA and ETOR estimates 148. In some embodiments, users can obtain more detail regarding new outages, available resources and remaining work to be performed in such embodiments in a variety of formats including those shown in FIGS. 14-A through 14-B. For example, FIG. 14A includes a restoration work plan display 2600 capable of displaying division dependent ETA and ETOR data. For example, in some embodiments, the restoration work plan display 2600 may include a division data field 2610a and an assessment data field 2640a, along with a repair data field 2680a with ETA and ETOR data provided for a plurality of divisions as shown in the division data field 2610a. FIG. 14B shows additional division dependent ETA and ETOR data and also includes a division data field 2610b, an assessment data field 2640b and a repair data field 2680b.

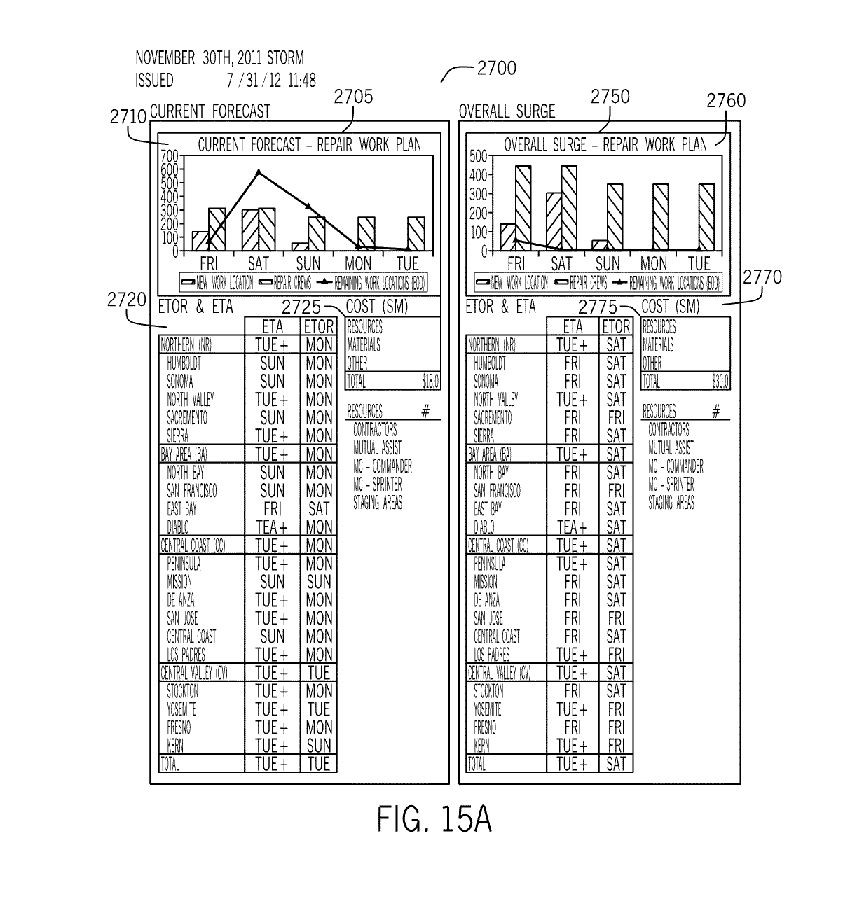

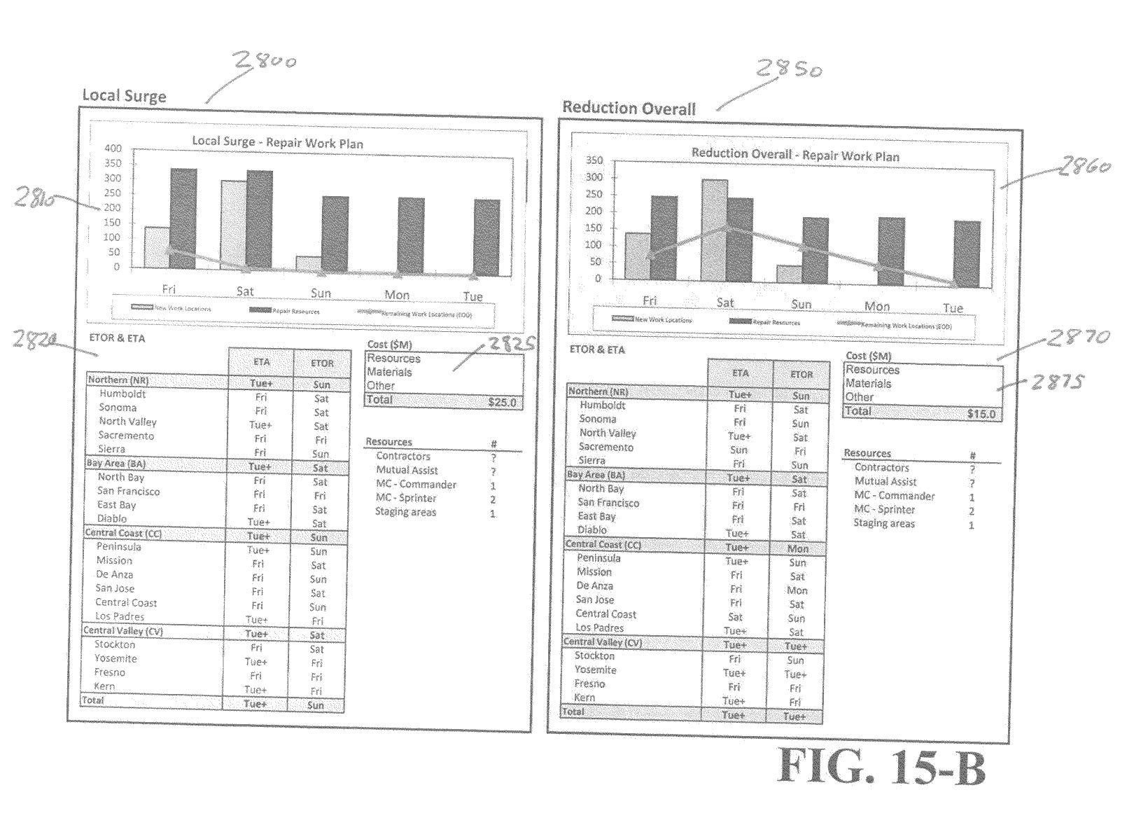

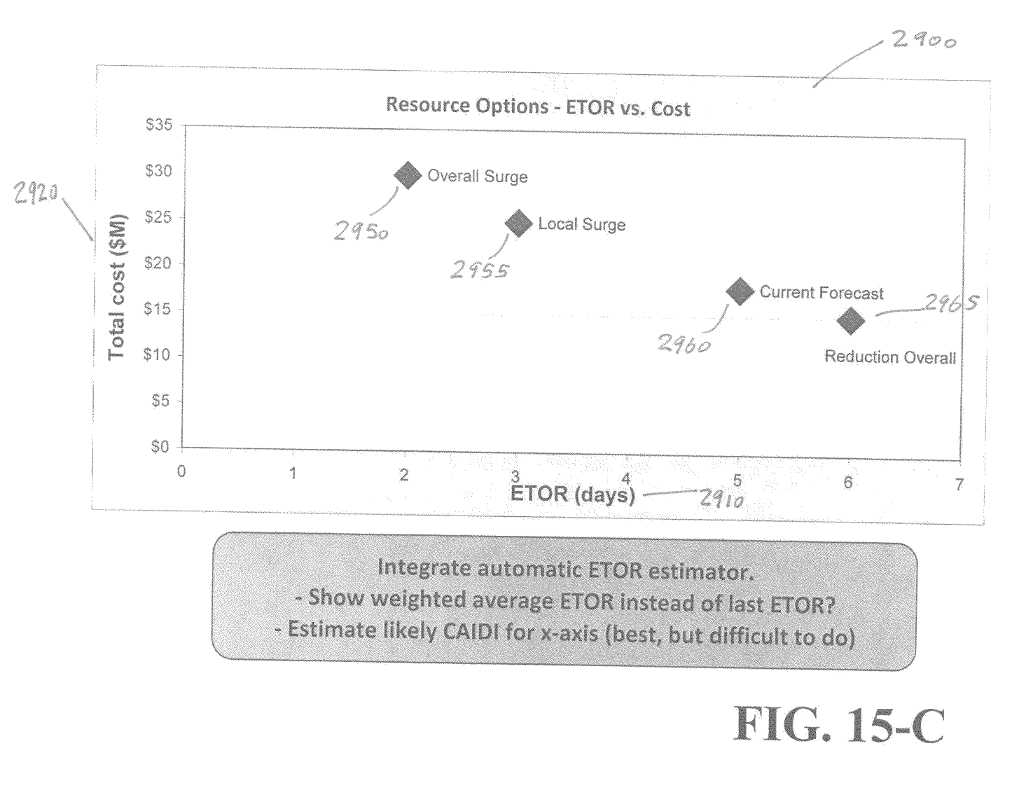

As shown in FIGS. 15A and 15B, the service restoration management system 10 can include analytical scenario analysis module that forecasts various restoration scenarios and compares total estimated system cost versus total estimated restoration time for each scenario. FIG. 15A illustrates a restoration scenario display 2700 that includes a current forecast 2705 and a overall surge 2750 data set. As shown, the current forecast 2705 data set can include forecast-repair work plan chart 2710, ETOR and ETA data 2720, along with a current forecast cost 2725. The overall surge 2750 is structured to show an overall surge-repair work plan chart 2760, ETOR and ETA data 2770, as well as overall surge cost 2775.

Some embodiments can display a repair work plan and ETOR and ETA based on a local surge and a reduction overall. For example, FIG. 15B illustrates a local surge 2800 display that can include a local surge-repair work plan chart 2810 and ETOR and ETA data 2820. FIG. 15B also shows a reduction overall 2850 display including a reduction overall-repair work plan chart 2860 and ETOR and ETA data 2870 As shown, each display 2800 and 2850 includes a cost display associated with resources and materials. For example, local surge 2800 display shows a local surge cost 2825, and the reduction overall 2850 display is shown with a reduction overall cost 2875 data.

FIG. 15C shows an output of one embodiment of the service restoration management system 10 that compares each scenario based on ETOR versus cost for each response option. As shown, the resource options chart 2900 enables a user to visualize resource cost scenarios by plotting ETOR 2910 as a function of total cost 2920. For example, FIG. 15C illustrates a comparison of the data discussed in FIGS. 15A-15B, showing a plot of overall surge 2950, local surge 2955, current forecast 2960, and reduction overall 2965. In some embodiments, the tools and displays shown in FIGS. 15A-C can enable to model resources options by comparing different scenarios of ETOR and total cost.

Some embodiments of the invention provide a system and method for managing service restoration 10 helping identify resource gaps and develop a resource transfer strategy according to one embodiment of the invention. As discussed earlier with respect to FIG. 8, in some embodiments, the service restoration management system 10 includes the resource transfer module 800 to clearly identify resource gaps by desired geographic region. As shown in FIG. 8, some embodiments of the resource transfer module 800 include a resource supply vs. demand chart 810 (with Bay area, California data in this example) from which data can be used within a regional transfer data display 850 (shown enlarged in FIG. 16A). Resource gaps are quickly identified and in some embodiments, ideal transfers automatically suggested. The ideal transfers can be selected as “ideal” based on any parameters set by the utility provider or other parties. The graphical display in FIG. 16A shows geographic regions color-coded by whether they have adequate resources compared to the restoration strategy, both before transfers are made and after suggested transfers are made. For example, FIG. 16A shows a regional transfer potential display 3000 according to some embodiments of the invention. As shown, the regional transfer potential display 3000 can include a regional transfer phase selected by a phase selector 3010. In some embodiments, the color coding of the regional map 3030 can be selected by a map coding 3020, and the map 3030 may be updated using the update map function 3025. In some embodiments, the regional map 3030 can include a plurality of regions 3035, one or more of which may include a tabulated display of assess and repair resource data. For example, FIG. 16A includes the sub-region data 3040, sub-region data 3050, sub-region data 3060 and sub-region data 3070 each of which correspond to one of the plurality of regions 3035. Further, the regional transfer potential display 3000 can also include a data key 3080 that may be applied to any one or more of the data of the sub-region data 3040, 3050, 3060 and 3070. For example, the data key 3080 can include resources adequate 3082, resources available 3084, and resources needed 3086, and any data within the sub-region data 3040, 3050, 3060 and 3070 may be assigned a data key 3080 that can include resources adequate 3082, resources available 3084, and resources needed 3086. In some embodiments, resources adequate 3082, resources available 3084, and resources needed 3086 can each be assigned a different color, and any data within the sub-region data 3040, 3050, 3060 and 3070 may be assigned a color from the data key 3080 that can include a color specific to resources adequate 3082, a color specific to resources available 3084, or a color specific to resources needed 3086. Further, in some embodiments, any one of the plurality of regions 3035 of the regional transfer potential display 3000 may be assigned a color from the data key 3080 that can include a color specific to resources adequate 3082, a color specific to resources available 3084, or a color specific to resources needed 3086, that represents a status of repair crews 345.

Some embodiments of the invention can incorporate current and available resource counts to identify the most effective transfer of resources in order to attain the resource staffing as required in the selected restoration strategy, as shown in FIGS. 16B through 16H. For example, FIG. 16B shows a display of a regional assessment phase data 3100. FIG. 16C shows one example of a pre-event resource transfer data table 3200, and FIG. 16D shows intra-regional resource transfers data table 3300, regional resource transfers data table 3310. Moreover, FIG. 16E shows one example of a repair resource transfer data table 3400, and FIG. 16F includes a resource assessment data table 3510, and a resource assessment data table 3520. Further, FIG. 16G shows one embodiment of a resource assessment data table 3600, and FIG. 16H shows a resource assessment data table 3700.

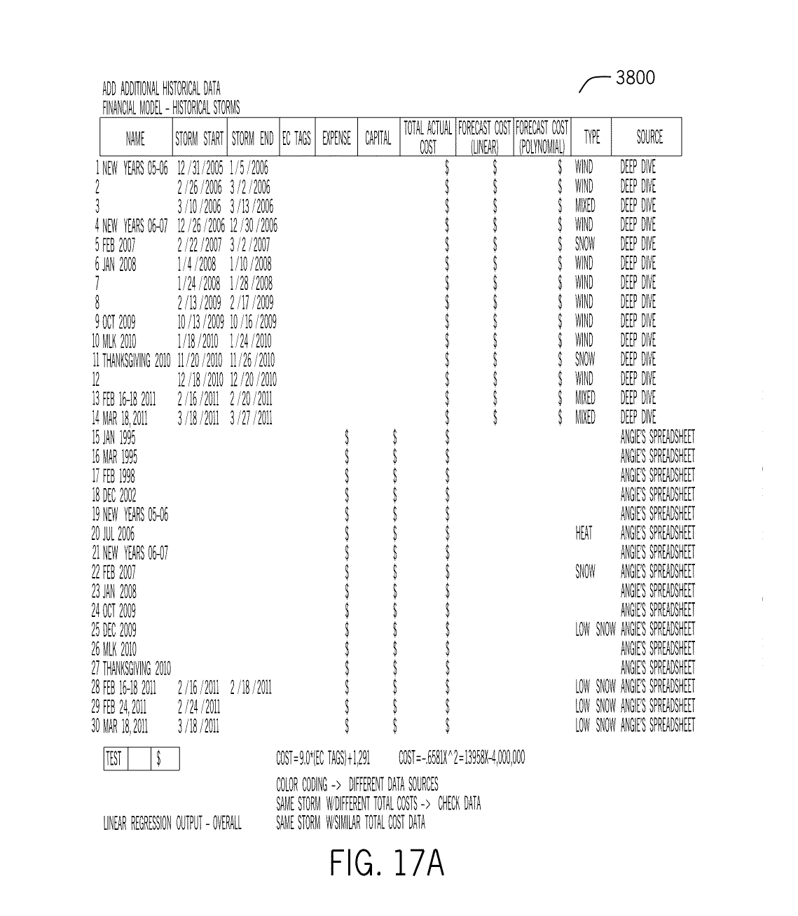

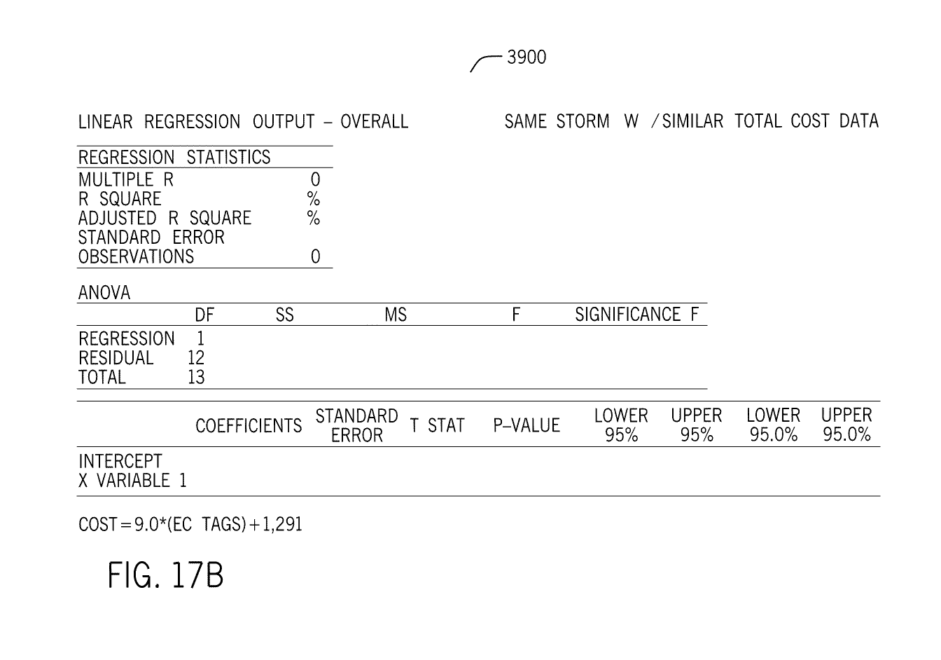

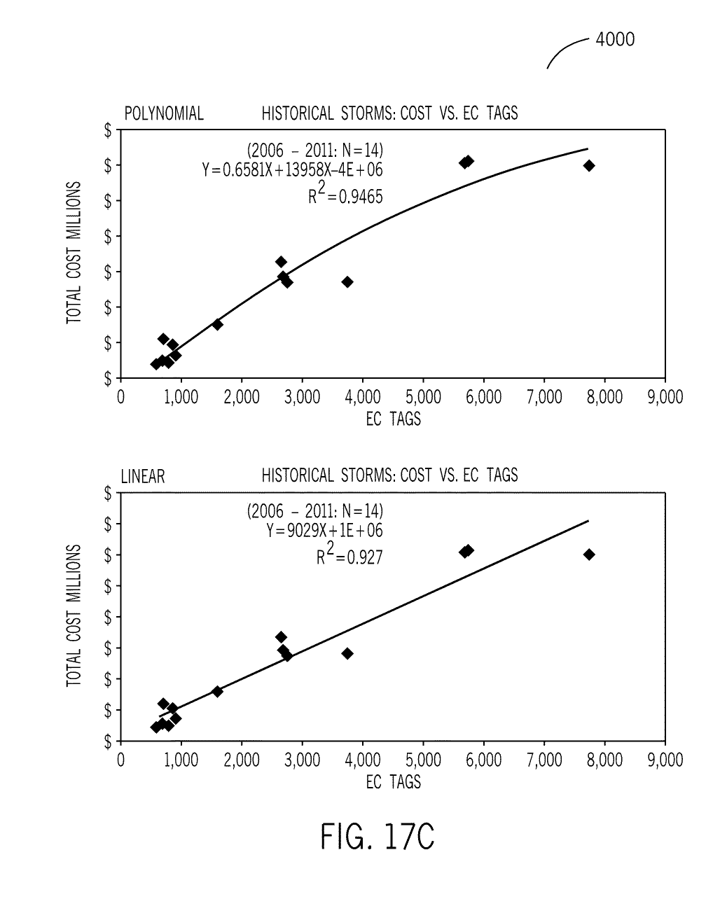

The ability to utilize historical data in combination with current observational data within the system and method for managing service restoration 10 can significantly improve the prediction accuracy of the DSO SOPP model. As noted earlier, some embodiments of the restoration work plan system 100 include data inputs 120 that include pre-event 122 data that includes historical productivity assumptions 128. Moreover, in some embodiments, the DSO SOPP model can utilize historical outage data in addition to or in place of weather forecast and observation data. In some embodiments, assumptions used as data inputs for the service restoration management system 10 can be based on historical productivity performance from past events and can be calculated based on type of weather event. In some embodiments, the service restoration management system 10 can store and utilize historical information regarding past storms including, without limitation, the dates and types of the storms, the number of outages and the associated expenses for each storm as shown in FIGS. 17-A through 17-C. Costs versus outages can be plotted to provide historical inputs into the service restoration management system 10 to calculate more accurate and efficient work plans. For example, FIG. 17A shows a financial model data table display 3800 that in this example, reveals storm related events and costs associated with restoration, and FIG. 17B includes a financial model data table display 3900. As shown in FIG. 17C, historical data can also be illustrated in financial data plots 4000.

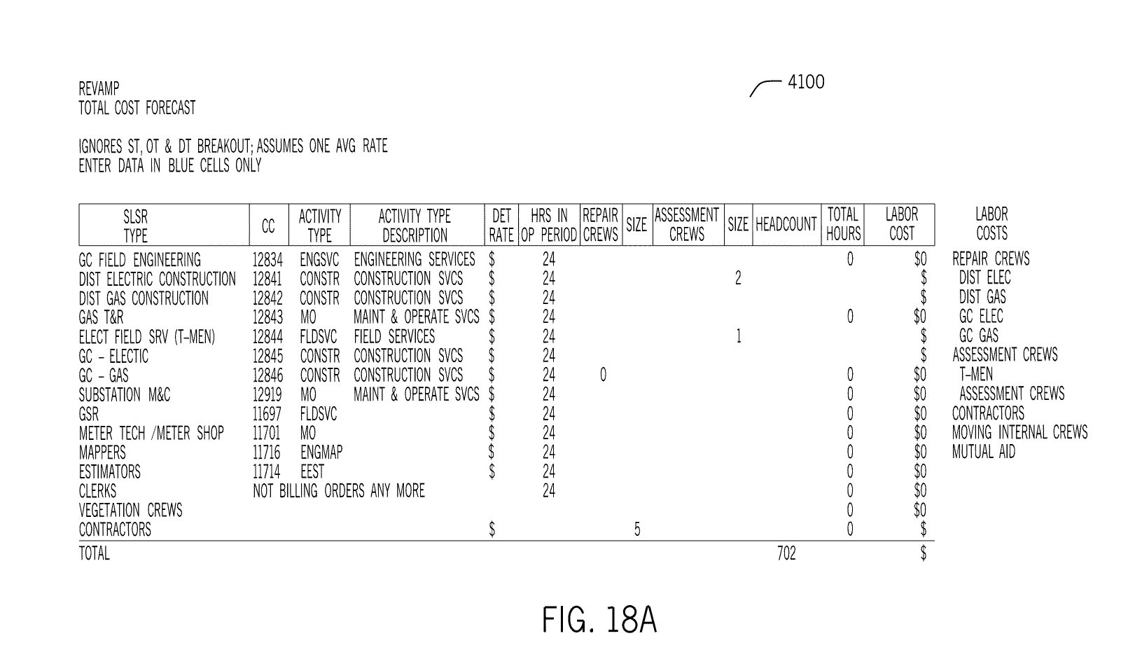

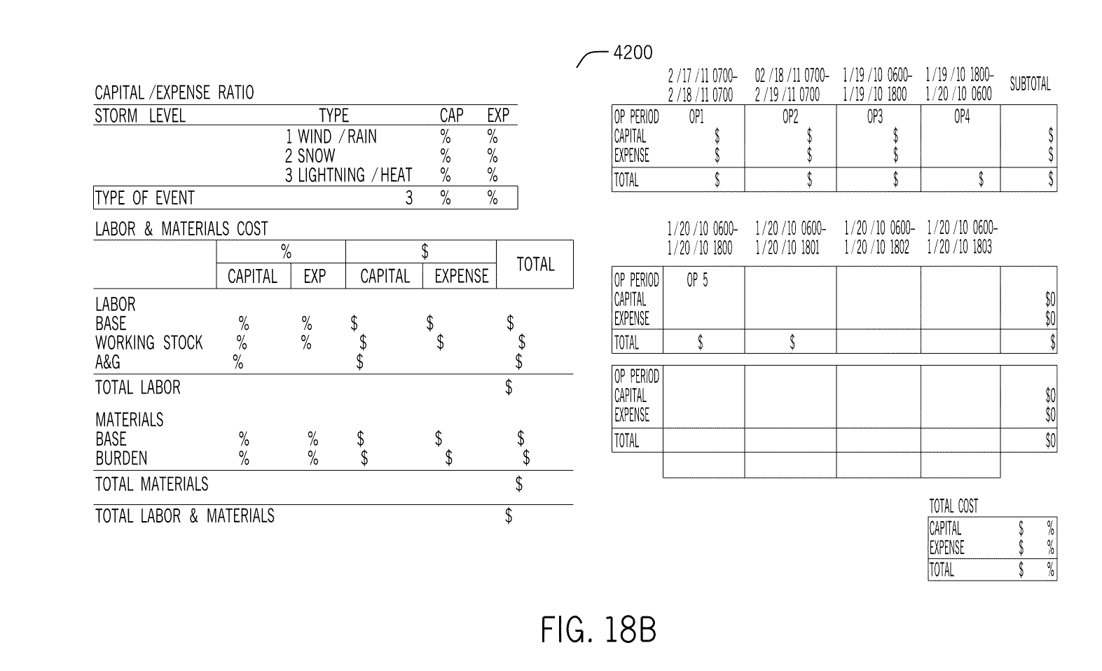

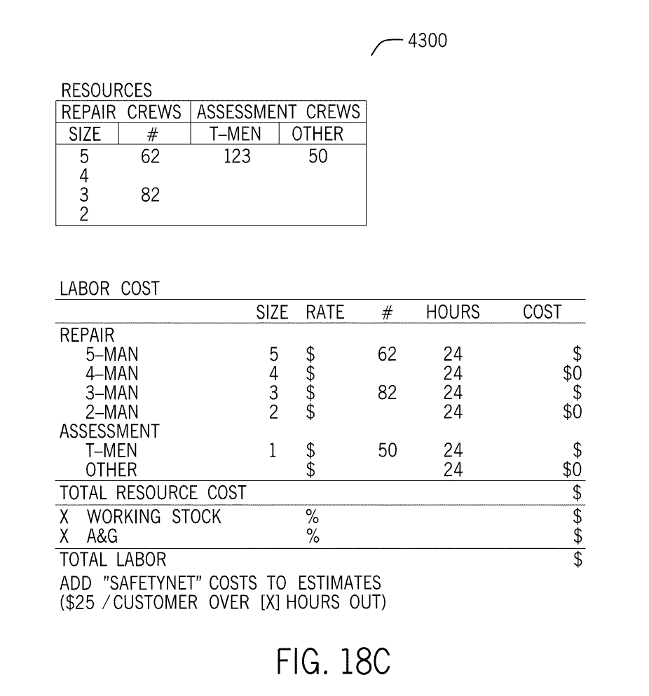

In some embodiments, the restoration management system 10 can calculate and display total estimated restoration costs during an event using some of the inputs shown in FIGS. 18-A through 18-C. These inputs and costs can be adjusted throughout the duration of an event, providing ever more accurate event costs as the event progresses. These cost estimates can be reported to management and included in the scenario analysis 162 modules and/or other profit and loss modules 160 (e.g., current status and performance dashboard 164, resource transfer analysis 166, and the financial estimator 168) of the restoration management system 10 to improve development of an ideal restoration strategy. For example, FIG. 18A includes one example of a total cost forecast data display 4100, FIG. 18B shows a total cost forecast data display 4200, and finally FIG. 18C shows a total cost forecast data display 4300.

The restoration management system 10 can be integrated to perform any or all analyses and actions automatically. Furthermore, data inputs from others systems, such as current resource counts, weather forecasts, and customer outage counts, can be automatically integrated into the system rather than batch uploaded. These fully integrated solutions can be programmed to adjust in real-time to any new data input. Additionally, assumptions, scenarios and restoration strategy can also be adjusted in real-time by the system operators to provide a real-time decision-support system to aid in the management of emergency events.

The restoration management system 10 in its most comprehensive of embodiments can provide automatic and real-time support to emergency event management. Some embodiments analyze the current state of restoration efforts, calculate the ideal restoration strategy based on current resources and taking into consideration both utility and customer costs, recommend the most efficient transfer of resources to attain that restoration strategy, and provide comprehensive reporting and monitoring capabilities to manage an event in real-time. The system can adjust to new information and can recalculate ideal restoration strategy and resource transfers in real-time.

The above-described databases and models throughout the system 10 can store analytical models and other data on computer-readable storage media. In addition, the above-described applications of the monitoring system 10 can be stored on computer-readable storage media. With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations may be described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A computer-implemented restoration work plan system, the system comprising:
a processor;
a non-transitory computer-readable storage medium in data communication with the processor,
the non-transitory computer-readable storage medium including a service restoration management system executable by the processor, and configured to:
prepare a first distribution system operations storm outage prediction project model forecast including at least an assessment plan and a repair plan by performing the steps executable by the processor comprising:
calculating and displaying an expected outage category level substantially in real time for the at least one division based at least in part on at least one variable of the weather forecast; and
calculating and displaying a sustained outage for the at least one division based at least in part on the expected outage category level and a historical sustained outage based on the expected outage category;
calculating and displaying a customers experiencing sustained outages figure report based at least in part on a historical relationship of the calculated sustained outage to a historical customers experiencing sustained outages figure report of the at least one division; and
calculating and displaying estimated resource numbers based on the calculated sustained outage and the resource numbers comprising the number of personnel needed to respond to outages and the number of crew needed to repair outages.

2. The system of claim 1, and further comprising the service restoration management system executable by the processor and configured to:
calculate and display an estimated time of assessment of an expected outage within the assessment plan; and
calculate and display an estimated time of repair within the repair plan based at least in part on a historical productivity assumption, the productivity assumption including a historical rate of assessment and repair and percentage of outages requiring repair.

3. The system of claim 1, wherein the resource numbers are based on the calculated sustained outage and the number of crews and personnel needed to repair outages within 12 hours when the outage category level is 3 or lower.

4. The system of claim 1, wherein the resource numbers are based on the calculated sustained outage and the number of crews and personnel needed to repair outages within 24 hours when the outage category level is 4 or greater.

5. The system of claim 1, wherein the outage category level can range in increments of 1 between 1 and 5, and wherein the outage category level can be assigned a qualitative weather comprising at least one of a “adverse weather unlikely”, “adverse weather possible”, “adverse weather likely”, “extreme weather possible” and “extreme weather likely”.

6. The system of claim 1, wherein the first distribution system operations storm outage prediction project model forecast is prepared for each division for four successive days.

7. The system of claim 6, wherein the first distribution system operations storm outage prediction project model forecast is calculated and displayed in one day increments.

8. The system of claim 7, wherein the one day increments include a forecasted timing of most intense outage producing forecast weather.

9. The system of claim 2, wherein the service restoration management system comprises a non-transitory computer-readable storage medium comprising instructions to perform a restoration option scenario analysis,
the instructions executable by the processor, and configured to:
calculate at least a second distribution system operations storm outage prediction project model forecast using the service restoration management system in addition to the first distribution system operations storm outage prediction project model forecast in which at least one of the expected outage category level, the customers experiencing sustained outages figure report, resource numbers, the estimated time of assessment and the estimated time of repair is different from that used in the first distribution system operations storm outage prediction project model forecast; and
calculate and display at least the first distribution system operations storm outage prediction project model forecast including a first repair plan and the at least second distribution system operations storm outage prediction project model forecast including a second repair plan within a resource decision tool.

10. The system of claim 9, wherein the first repair plan includes a first plan cost and the second repair plan includes a second plan cost; and
wherein the restoration option scenario analysis further includes a graphical display comparing the first plan cost with at least the second plan cost.

11. The system of claim 2, wherein the repair plan further comprises a plan cost based at least on the estimated time of repair.

12. The system of claim 11, wherein a total system cost and a lowest system cost can be determined based on the estimated time of repair, the plan cost and a societal cost based on the sustained outage and estimated time of repair.

13. The system of claim 2, wherein the resource numbers are calculated based on transferred resources, the transferred resources including personnel or crew or both initially located outside of the division.

14. The system of claim 13, wherein the repair plan further comprises a plan cost based at least on the estimated time of repair and a transferred resources cost.

15. The system of claim 2, wherein the service restoration management system comprises a non-transitory computer-readable storage medium comprising instructions to perform a divisional estimated time of repair forecast comparison,
the instructions executable by the processor, and configured to:
calculate estimated time of repair across a plurality of divisions;
identify divisions with resource needs based on sustained outage for each division and resource numbers available locally within the division;
calculate and display resource numbers based on transferred resources, the transferred resources including personnel or crew or both initially located outside of the division.

16. The system of claim 2, wherein calculating and displaying an estimated time of assessment of an expected outage within the assessment plan and calculating and displaying an estimated time of repair within the repair plan occurs within 0.5 seconds or less of calculating and displaying an expected outage category level.

17. A non-transitory computer-readable storage medium storing computer-readable instructions, which when executed by at least one processor of a computer, cause a restoration work plan system to perform steps comprising:
receiving and storing on a computer-readable storage medium a first file comprising at least one weather forecast including at least one storm comprising a storm type and size for at least one division; and
using the least one processor, preparing a first distribution system operations storm outage prediction project model forecast including at least an assessment plan and a repair plan by performing the steps comprising:
calculating and displaying an expected outage category level substantially in real time for the at least one division based at least in part on at least one variable of the weather forecast; and
calculating and displaying a sustained outage for the at least one division based at least in part on the expected outage category level and a historical sustained outage based on the expected outage category;
calculating and displaying a customers experiencing sustained outages figure report based at least in part on a historical relationship of the calculated sustained outage to a historical customers experiencing sustained outages figure report of the at least one division; and
calculating and displaying estimated resource numbers based on the calculated sustained outage and the resource numbers comprising the number of personnel needed to respond to outages and the number of crew needed to repair outages.

18. The method of claim 17, and further comprising:
calculating and displaying an estimated time of assessment of an expected outage within the assessment plan; and
calculating and displaying an estimated time of repair within the repair plan based at least in part on a historical productivity assumption,
the productivity assumption including a historical rate of assessment and repair and percentage of outages requiring repair.

19. The method of claim 17, wherein the resource numbers are based on the calculated sustained outage and the number of crews and personnel needed to repair outages within 12 hours when the outage category level is 3 or lower.

20. The method of claim 17, wherein the resource numbers are based on the calculated sustained outage and the number of crews and personnel needed to repair outages within 24 hours when the outage category level is 4 or greater.

21. The method of claim 17, wherein the outage category level can range in increments of 1 between 1 and 5, and wherein the outage category level can be assigned a qualitative weather comprising at least one of a “adverse weather unlikely”, “adverse weather possible”, “adverse weather likely”, “extreme weather possible” and “extreme weather likely”.

22. The method of claim 17, wherein the first distribution system operations storm outage prediction project model forecast is prepared for each division for a successive four days.

23. The method of claim 22, wherein the first distribution system operations storm outage prediction project model forecast is calculated and displayed as one day increments.

24. The method of claim 23, wherein the one day increments include a forecasted timing of most intense outage producing forecast weather.

25. The method of claim 18, further including preparing a restoration option scenario analysis,
the scenario analysis comprising the steps of preparing at least a second distribution system operations storm outage prediction project model forecast using the method of preparing the first distribution system operations storm outage prediction project model forecast in which at least one of the expected outage category level, the customers experiencing sustained outages figure report, resource numbers, the estimated time of assessment and the estimated time of repair is different from that used in the first distribution system operations storm outage prediction project model forecast; and
displaying at least the first distribution system operations storm outage prediction project model forecast including a first repair plan and the at least second distribution system operations storm outage prediction project model forecast including a second repair plan within a resource decision tool.

26. The method of claim 25, wherein the first repair plan includes a first plan cost and the second repair plan includes a second plan cost; and
wherein the restoration option scenario analysis further includes a graphical display comparing the first plan cost with at least the second plan cost.

27. The method of claim 18, wherein the repair plan further comprises a plan cost based at least on the estimated time of repair.

28. The method of claim 27, wherein a total system cost and a lowest system cost can be determined based on the estimated time of repair, the plan cost and a societal cost based on the sustained outage and estimated time of repair.

29. The method of claim 18, wherein the resource numbers are calculated based on transferred resources, the transferred resources including personnel or crew or both initially located outside of the division.

30. The method of claim 29, wherein the repair plan further comprises a plan cost based at least on the estimated time of repair and a transferred resources cost.

31. The method of claim 18, further comprising developing a divisional estimated time of repair forecast comparison, the divisional estimated time of repair forecast comparison prepared by the steps of:
calculating estimated time of repair across a plurality of divisions;
identifying divisions with resource needs based on sustained outage for each division and resource numbers available locally within the division;
calculating resource numbers based on transferred resources, the transferred resources including personnel or crew or both initially located outside of the division.

32. The method of claim 18, wherein calculating and displaying an estimated time of assessment of an expected outage within the assessment plan and calculating and displaying an estimated time of repair within the repair plan occurs within 0.5 seconds or less of calculating and displaying an expected outage category level.
